(19) United States
(12) Patent Application Publication
(10) Pub. No.: US 2002/0039628 A1
(43) Pub. Date: Apr. 4, 2002

(54) LIQUID CRYSTAL ALIGNMENT FILM, METHOD OF PRODUCING THE SAME, LIQUID CRYSTAL DISPLAY MADE BY USING THE FILM, AND METHOD OF PRODUCING THE SAME

(76) Inventor: KAZUFUMI OGAWA, NARA-SHI (JP)

Correspondence Address: MERCHANT & GOULD PC, P.O. BOX 2903, MINNEAPOLIS, MN, 55402-0903, US

(21) Appl. No.: 09/230,490

(22) PCT Filed: May 21, 1998
(86) PCT No.: PCT/JP98/02254

(51) Int. Cl. C09K 19/00

(52) U.S. Cl. 428/1.2

(57) ABSTRACT

A liquid crystal alignment film comprising a molecule group with one end thereof chemically adsorbed on the surface of a substrate, wherein the molecule group contains molecules each having a linear carbon chain and at least part of the linear carbon chains are selectively polymerized, thus suppressing the panel having a large area and the substrate surface having a stepped portion from losing the uniformity of alignment. Since the liquid crystals are aligned without resort to any physical contact means such as rubbing, an increased area of the panel and the stepped portion on the surface of the substrate do not basically affect the uniformity of alignment. Since the liquid crystal alignment film is chemically adsorbed on the surface of the substrate, the film exhibits excellent properties in the durability of the film, such as resistance against peeling.

### TECHNICAL FIELD

The present invention relates to a liquid crystal alignment film and a method for producing the same, and a liquid crystal display apparatus using the alignment film and a method for producing the same. More specifically, the present invention relates to a liquid crystal alignment film used for a flat display panel employing liquid crystal for displaying images on television (TV) and computers or the like, and a method for producing such a liquid crystal alignment film, a translucent substrate that can preferably be used for the production, and also relates to a liquid crystal display apparatus employing the alignment film and a method for producing such a liquid crystal display apparatus.

### BACKGROUND ART

Conventionally, as a color liquid crystal display panel, an apparatus generally used includes liquid crystal that is injected between two substrates provided with counter electrodes arranged in a matrix array via a liquid crystal alignment film formed by rotary-coating a polyvinyl alcohol or a polyimide solution with a spinner or the like.

For example, the following device is well known. The device comprises a first substrate and a second substrate. Thin film transistor (TFT) arrays having pixel electrodes are formed on the first glass substrate, a plurality of color filters of red, blue and green are formed on a second glass substrate, and common transparent electrodes are further formed thereon. The surfaces provided with the respective electrodes are coated with a . polyvinyl alcohol or a polyimide solution with a spinner or the like so as to form films. Then, the film is subjected to a rubbing treatment to form liquid crystal alignment films, and the two substrates are positioned via spacers so that they are facing each other. Thereafter, liquid crystal (twist nematic (TN) liquid crystal or the like) is injected between the first and the second substrate to form a panel structure. Then, polarizing plates are provided on the front and back of the panel. While the panel is irradiated with backlight from the back side, TFTs are operated. Thus, color images are displayed.

However, in the conventional alignment film, polyvinyl alcohol or polyimide is dissolved in an organic solvent and the resultant solution is applied by rotary-coating method or the like. Then, rubbing is performed with a felt cloth or the like. Therefore, there is a problem in that uniformity in the alignment film is poor in surface step portions or over a large area panel such as a 14 inch display. Furthermore, it is difficult to make the film thickness of the resin alignment film thin. And there is a problem in that a liquid crystal display apparatus using such an alignment film tends to generate display inconsistency or image sticking.

### DISCLOSURE OF THE INVENTION

In order to solve the above-mentioned problems, it is a first object of the present invention to provide a liquid crystal alignment film suitably used for a liquid crystal display panel, which can maintain the uniformity of the alignment even in the surface step portions or over a large area panel; a method for efficiently producing the crystal liquid alignment film without performing a rubbing treatment; a translucent substrate suitably used for the production; a liquid crystal display apparatus using the liquid crystal alignment film and the method for producing the liquid crystal display apparatus.

Moreover, it is a second object of the present invention to provide an alignment film that is used for a liquid crystal display panel, wherein the film thickness is remarkably thin and the alignment direction of liquid crystal is controlled by rubbing, the pre-tilt angle of liquid crystal can be controlled by controlling the critical surface energy of the alignment film; a method for efficiently producing the liquid crystal alignment film; and a liquid crystal display apparatus using the liquid crystal alignment film and the method for producing the same.

In order to achieve the first object, a first liquid crystal alignment film of the present invention is a film comprising a group of molecules being chemically adsorbed at one end to a surface of a substrate, the group of molecules comprising molecules having a linear carbon chain, wherein at least a part of the linear carbon chains are selectively polymerized with each other.

According to such a liquid crystal alignment film, the deterioration of the alignment uniformity can be inhibited even on the surface of a substrate having a large area panel or surface step portions. Since this liquid crystal alignment film is provided with an alignment property with respect to liquid crystal not by physical contact means such as rubbing, the increased area of the panel or the step portion on the surface of the substrate does not basically affect the uniformity of the alignment of liquid crystal. Furthermore, since the liquid crystal alignment film is chemically adsorbed to the surface of the substrate, the durability of the film such as peeling resistance is also excellent.

It is preferable in the above-mentioned liquid crystal alignment film that the linear carbon chains are polymerized, thereby controlling a tilt of the linear carbon chain with respect to the substrate at a constant angle. Thus, the alignment regulation force with respect to the liquid crystal can be improved.

Furthermore, it is preferable in the above-mentioned liquid crystal alignment film that the group of molecules includes molecules being shorter than the molecules having a linear carbon chain, the tilt of the linear carbon chain with respect to the substrate is controlled to a constant angle by the presence of the shorter molecules, at least a part of the linear carbon chains are selectively polymerized with each other, thereby increasing or decreasing the tilt of the linear carbon chain with respect to the substrate from the angle, and by increasing or decreasing the tilt, a region in which the linear carbon chains are polymerized forms a convex portion or a concave portion. With such a preferable example, the concave portion and convex portion on the surface of the film controlled on the molecular level contribute to the improvement of the regularity in the liquid crystal alignment.

Furthermore, it is preferable in the above-mentioned liquid crystal alignment film that the region in which the linear carbon chains are polymerized forms a plurality of lines, which are substantially parallel to each other, on the surface of the substrate via a region in which the linear carbon chains are not polymerized. With such a preferable example, the alignment regulation force with respect to liquid crystal is further improved. In particular, the alignment regulation force is improved remarkably in the surface of the liquid crystal alignment film in a case where the above-mentioned convexities or concavities extend in the same direction.

Furthermore, it is preferable in the above-mentioned liquid crystal alignment film that the molecules having linear carbon chains are fixed at one end to the surface of the substrate via siloxane bonds. This is advantageous because peeling resistance of the liquid crystal alignment film or the like is further improved.

Furthermore, it is preferable in the above-mentioned liquid crystal alignment film that the molecules constituting the group of molecules are bonded to each other via siloxane bonds. With such a preferable example, peeling resistance or the like can further be improved. In addition, the precision of alignment of the linear carbon chains with respect to the substrate can be improved further.

In order to achieve the above-mentioned first object, a first method for producing a liquid crystal alignment film of the present invention comprises the steps of fixing the molecules to a surface of the substrate at one end by contacting the surface of the substrate with a chemisorption solution so as to cause a chemical reaction between surfactant molecules having linear carbon chains in the chemisorption solution and hydrophilic groups contained on the surface; and providing at least a part of linear carbon chains with the alignment property with respect to the substrate by selectively exposing the film comprising the group of molecules including the above-mentioned molecules to light.

According to this method for producing a liquid crystal alignment film, rubbing is not performed, so that the liquid crystal alignment film having uniformity even over a large area panel or surface step portion can be efficiently and rationally produced. In addition, since the alignment regulation force with respect to the liquid crystal is provided by using the change of the alignment of linear carbon chains by exposure, the productivity basically is not deteriorated even if the area of the panel is increased.

It is preferable in the above-mentioned method for producing a liquid crystal alignment film that the step of providing at least a part of linear carbon chains with the alignment property with respect to the substrate is a step of controlling a tilt of the linear carbon chains with respect to the substrate at a constant angle by polymerizing the linear carbon chains. With such a preferable example, a tilt of the linear carbon chain with respect to the substrate is fixed, and thereby a liquid crystal alignment film improving the precision in the alignment of liquid crystal can be produced.

Furthermore, it is preferable in the above-mentioned method for producing a liquid crystal alignment film that along with the surfactant molecules having linear carbon chains, molecules having shorter molecular length than the surfactant molecules are fixed at one end to the surface of the substrate, thereby controlling the tilt of the linear carbon chain with respect to the substrate to a constant angle, at least a part of the linear carbon chains are selectively polymerized with each other, thereby increasing and decreasing the tilt of the linear carbon chain with respect to the substrate from the above-mentioned angle, and by increasing or decreasing the tilt, a region in which the linear carbon chains are polymerized forms a convex portion or a concave portion. With such a preferable example, a film in which convexities or concavities controlled on the molecular level on the surface of the film contribute to the improvement of the alignment regulation force with respect to liquid crystal can be produced.

Furthermore, it is preferable in the above-mentioned method for producing a liquid crystal alignment film that the step of washing the surface of the substrate with an organic solvent is performed after the step of fixing the surfactant molecules having linear carbon chains to the surface at one end and before the step of exposing the film comprising a group of molecules including the above-mentioned molecules to light. With such a preferable example, extra surfactant molecules can be removed together with organic solvent that is not fixed to the surface of the substrate. Consequently, the obtained liquid crystal alignment film can be made a monomolecular film, thereby further improving the alignment regulation force, peeling resistance, or the like.

Furthermore, it is preferable in the above-mentioned method for producing a liquid crystal alignment film that the organic solvent is drained off the surface of the substrate in a predetermined direction during the step of washing the surface of the substrate with organic solvent, thereby aligning the linear carbon chains in the predetermined direction. With such a preferable example, a tilt of the linear carbon chain can be primarily aligned, so that the precision of the alignment of liquid crystal can be improved.

Furthermore, it is preferable in the above-mentioned method for producing a liquid crystal alignment film that the organic solvent is drained off from the surface of the substrate in the predetermined direction, thereby controlling the tilt of the linear carbon chains with respect to the substrate to a constant angle, at least a part of the linear carbon chains are selectively polymerized with each other, thereby increasing or decreasing the tilt of the linear carbon chains with respect to the substrate from the angle, and by increasing or decreasing the tilt, a region in which the linear carbon chains are polymerized forms a convex portion or a concave portion. Such a preferable example makes it possible to produce a liquid crystal alignment film in which convexities or concavities being controlled on the molecular level on the surface of the film contribute to the improvement of the alignment regulation force with respect to liquid crystal. As a method for providing a linear carbon chain with the primarily alignment, when combining the method in which the organic solvent is drained off in the predetermined direction and the method of fixing the surfactant molecules shorter than the surfactant molecules having linear carbon chains together with surfactant molecules having a linear carbon chain at one end to the surface of the substrate, a liquid crystal alignment film capable of improving the precision of the alignment of liquid crystal can be obtained.

Furthermore, it is preferable in the above-mentioned method for producing a liquid crystal alignment film that a nonaqueous organic solvent containing at least one selected from the group consisting of an alkyl group, a carbon fluoride group, a carbon chloride group and a siloxane group is used as the organic solvent. With such a preferable example, in the washing step, the reaction between the extra surfactant molecules and moisture in the air can be inhibited. Consequently, a good monomolecular film can be obtained by effectively removing the extra surfactant molecules.

Furthermore, it is preferable in the above-mentioned method for producing a liquid crystal alignment film that exposure is performed via a translucent substrate provided with a plurality of convexities and concavities extending in approximately the same direction, so that the region in which the linear carbon chains are polymerized forms a plurality of lines, which are substantially parallel to each other, on the surface of the substrate via a region in which the linear carbon chains are not polymerized. With such a preferable example where the exposure is performed selectively, the liquid crystal alignment film in which the alignment regulation force is further improved can be produced. The alignment regulation force can be remarkably improved particularly in a case where the convexities and concavities extend in the same direction on the surface of the liquid crystal alignment film.

Furthermore, it is preferable in the above-mentioned method for producing a liquid crystal alignment film that the exposure is performed via a translucent substrate having the width and depth of a concave portion of the convexities and concavities on the surface in the range from 0.01 to 0.5 μm. In addition, it is preferable that light reaching to the film through a translucent substrate is diffracted by the convexities and concavities of the translucent substrate. This is advantageous because the alignment regulation force can be improved.

Furthermore, it is preferable in the above-mentioned method for producing a liquid crystal alignment film that the surfactant molecules having linear carbon chains comprise a silicone-containing group selected from the group consisting of a chlorosilane group, an alkoxysilane group and an isocyanate silane group at the terminal. This is advantageous because the chemically adsorbed film having an excellent peeling resistance can be efficiently produced.

Furthermore, it is preferable in the above-mentioned method for producing a liquid crystal alignment film that the surfactant molecules having linear carbon chains comprise a photopolymerization functional group in the linear carbon chain. Furthermore, it is preferable that the photopolymerization functional group is a diacetylene group. With such preferable examples, linear carbon chains are efficiently polymerized by exposure.

Another embodiment of a first method for producing a liquid crystal alignment film of the present invention is characterized by comprising the steps of contacting the surface of the substrate with a chemisorption solution so as to cause a chemical reaction between surfactant molecules having linear carbon chains contained in the chemisorption solution and hydrophilic groups contained on the surface of the substrate, thereby fixing the molecules to the surface at one end; washing and drying the surface by draining off the organic solvent contacted with the surface in a predetermined direction, and exposing the film comprising a group of molecules comprising the above-mentioned molecules to light via a translucent substrate, wherein the translucent substrate provided with a plurality of convexities and concavities extending in approximately the same direction is positioned so that the direction in which the convexities and concavities extend is not orthogonal to the direction in which the solvent is drained off. According to this embodiment, when the film is exposed to light via the translucent substrate on which a plurality of convexities and concavities extend in approximately the same direction, the translucent substrate is positioned so that the direction in which the convexities and concavities extend is not orthogonal to the direction in which the organic solvent is drained off. Consequently, the precision of liquid crystal orientation can be further improved. Moreover, herein “positioned so that—not orthogonal to—” means that only strictly orthogonal position is excluded, and therefore the position in which they nearly orthogonal is included.

A first liquid crystal display apparatus according to the present invention is characterized in that two substrates being positioned with a predetermined space and being provided with a liquid crystal alignment film on at least one of surfaces facing each other, and the liquid crystal that is interposed between the two substrates in which alignment is regulated by the liquid crystal alignment film, wherein the liquid crystal alignment film is a film comprising a group of molecules chemically adsorbed to the surface of the substrate at one end, the group of molecules comprise molecules having linear carbon chains, wherein at least a part of the linear carbon chains are selectively polymerized with each other. In such a liquid crystal display apparatus, the deterioration of uniformity of the liquid crystal alignment film can be inhibited even over a large area panel or step portion of the surface of the substrate, and thereby alignment property of the liquid crystal is well maintained.

It is preferable in the above-mentioned liquid crystal display apparatus that the linear carbon chains are polymerized, thereby controlling the tilt of the linear carbon chain with respect to the substrate at a constant angle. This is advantageous because the alignment regulation force with respect to the liquid crystal can be improved.

Furthermore, the above-mentioned liquid crystal display apparatus is characterized in that the deterioration of the uniformity of the liquid crystal alignment in step portions can be inhibited, which occurred in a case where the liquid crystal alignment film is produced by rubbing, even if at least one thin film member selected from the group consisting of an electrode, a color filter and a thin film transistor is formed on a part of the surface of the substrate to form step portions on the surface, and a liquid crystal alignment film is formed in the region including the step portions.

Furthermore, it is preferable in the above-mentioned liquid crystal display apparatus that the liquid crystal alignment film includes a plurality of regions having different alignment directions. This is advantageous because the apparatus having a wide angle of visibility can be obtained.

In order to achieve the above-mentioned first object, a second method for producing a liquid crystal alignment film of the present invention is characterized by comprising the step of forming a plurality of convexities and concavities extending in approximately the same direction on the film formed on the surface of the substrate by the step of exposure.

According to such a method, the predetermined pattern of convexities and concavities on the surface is formed by changing the molecular structure through the step including exposure instead of rubbing. Consequently, the deterioration of uniformity of liquid crystal orientation can be inhibited even in the step portions or over a large area panel. It is preferable in the above-mentioned method for producing a liquid crystal alignment film that the width of the concave portion of the convexities and concavities is in the range from 0.01 to 0.5 μm. This is advantageous because the alignment regulation force with respect to liquid crystal is improved.

It is preferable in the above-mentioned method for producing a liquid crystal alignment film that the film is a chemisorption polymer film. With such a preferable example, the durability of the film such as peeling resistance can be improved.

It is preferable in the above-mentioned method for producing a liquid crystal alignment film that the chemisorption polymer film is bonded to the surface of the substrate via siloxane bonds. This is advantageous because the property of the liquid crystal, for example, peeling resistance, can be further improved.

Furthermore, another embodiment of the method for producing a second liquid crystal alignment film of the present invention is characterized by comprising the steps of forming a film comprising a photosensitive polymer on the surface of the substrate; exposing the film to light so that an exposed portion forms lines, which are approximately parallel with each other, via an unexposed portion; and forming a plurality of convexities and concavities extending in approximately the same direction by removing a part of the film by the use of the difference in the molecular structure of the molecules constituting the film generated by exposure.

According to such a method for producing a liquid crystal alignment film, the pattern of convexities and concavities on the surface is formed by the step including exposure instead of rubbing. Consequently, a liquid crystal alignment film in which the deterioration of uniformity of liquid crystal orientation is inhibited even in the step portions or a large area panel can be produced. In addition, even if the area of the panel is increased, the productivity essentially is not deteriorated.

It is preferable in the above-mentioned method for producing a liquid crystal alignment film that the difference in the molecular structure of the molecule constituting the above-mentioned film generated by exposure is a difference in the polymerization degree of the molecules constituting the film.

Furthermore, it is preferable in the above-mentioned method for producing a liquid crystal alignment film that the exposure is performed via a translucent substrate provided with a plurality of convexities and concavities extending in approximately the same direction on its surface. This is advantageous because the production can be performed simply and efficiently.

Furthermore, it is preferable in the above-mentioned method for producing a liquid crystal alignment film that the step of exposing the film to light is a step of exposing the film so that an exposed portion forms lines extending in approximately the same direction as the direction in which the convexities and concavities on the surface of the translucent substrate extend. Furthermore, it is preferable that patterns of convexities and concavities on the surface of the translucent substrate are transferred as patterns of the exposed portion and the unexposed portion. With such preferable examples, the liquid crystal alignment film providing a high alignment regulation force in the constant direction can be efficiently produced.

Furthermore, it is preferable in the above-mentioned method for producing a liquid crystal alignment film that the width and depth of the concave portion of the convexities and concavities are in the range from 0.01 to 0.5 μm. This is advantageous because the alignment regulation force with respect to liquid crystal can be improved.

Furthermore, it is preferable in the above-mentioned method for producing the liquid crystal alignment film that the film comprising the photosensitive polymer is formed by contacting a solution containing the photosensitive surfactant molecules with the surface of the substrate so that the surfactant molecules are chemically adsorbed to the substrate. With such a preferable example, a chemisorption film having an excellent film duration such as peeling resistance can be produced.

Furthermore, it is preferable in the above-mentioned method for producing a liquid crystal alignment film that the surfactant molecules comprise a silicone-containing group selected from the group consisting of a chlorosilane group, an alkoxysilane group and an isocyanate silane group at the terminal. This is advantageous because a chemisorption film having a high peeling resistance can be efficiently produced.

Furthermore, the translucent substrate for exposing a liquid crystal alignment film to light is characterized by comprising a plurality of convexities and concavities extending in approximately the same direction on its surface. It is preferable that the width and depth of the convexities and concavities on the surface are in the range from 0.01 to 0.5 μm. These translucent substrates for exposure preferably can be used for a method for producing the liquid crystal alignment film and also can provide a liquid crystal alignment film with an excellent alignment regulation force.

Furthermore, a method for producing a translucent substrate for exposing a liquid crystal alignment film to light produces a translucent substrate for exposing a liquid crystal alignment film to light, which comprises a plurality of convexities and concavities extending in approximately the same direction on its surface, and is characterized in that the method comprises the steps of washing a transparent substrate, and rubbing the surface of the transparent substrate with a member whose hardness is higher than that of the transparent substrate in approximately the same direction.

It is preferable in the above-mentioned method for producing a translucent substrate for exposing a liquid crystal alignment film to light that the transparent substrate is a polycarbonate resin or an acrylic resin. In a case where the translucent substrate is made of resins as in this preferable example, a brush, scrubbing brush or the like may be used as the above-mentioned member (a member for rubbing a substrate). However, a rubbing cloth that has been conventionally used for producing a liquid crystal alignment film is preferably used.

Furthermore, according to another embodiment of a method for producing a translucent substrate for exposing a liquid crystal alignment film to light of the present invention, a method for producing a translucent substrate for exposing a liquid crystal alignment film to light, which comprises a plurality of convexities and concavities extending in approximately the same direction on its surface to light comprises the steps of washing a transparent substrate, applying a photosensitive resist to the surface of the transparent substrate, exposing the photosensitive resist to light so that an exposed portion fomrs a plurality of lines, which are approximately parallel, via an unexposed portion, and developing the photosensitive resist. According to this method, a translucent substrate for exposure having a high precision and a diffraction effect with respect to light can be produced.

It is preferable in the above-mentioned method for producing a translucent substrate for exposing a liquid crystal alignment film to light that the photosensitive resist is exposed to light by using at least one selected from the group consisting of ultraviolet rays, far ultraviolet rays and electron beam.

Furthermore, it is preferable that the above-mentioned method for producing a translucent substrate for exposing a liquid crystal alignment film to light further comprises, after the step of developing the photosensitive resist, an etching the surface by at least one method selected from the group consisting of chemical etching, plasma etching and sputter etching. With such a preferable example, the aspect ratio of convexity and concavity of the translucent substrate can be increased.

In order to achieve the above-mentioned first object of the present invention, a second liquid crystal display apparatus is characterized by comprising two substrates and liquid crystal, the two substrates being positioned with a predetermined space and being provided with a liquid crystal alignment film on at least one of surfaces facing each other, and the liquid crystal that is disposed between the two substrates in which alignment is regulated by the liquid crystal alignment film, wherein the liquid crystal alignment film has a plurality of concavities and convexities extending in approximately the same direction formed on the surface contacting with the liquid crystal by the step including exposure. In such a liquid crystal display apparatus, the alignment property of liquid crystal is well maintained even for a large area panel or step portions on the surface of the substrate.

The above-mentioned liquid crystal display apparatus is characterized in that the deterioration of the uniformity of the liquid crystal alignment in step portions can be inhibited as occurred in a case where the liquid crystal alignment film is produced by rubbing, even if at least one thin film member selected from the group consisting of an electrode, a color filter and a thin film transistor is formed on a part of the surface of the substrate to form step portions on the surface, and a liquid crystal alignment film is formed in the region including the step portions.

Furthermore, it is preferable in the above-mentioned liquid crystal display apparatus that the liquid crystal alignment film includes a plurality of regions having different alignment directions. This is advantageous because a display apparatus having a large angle of visibility can be obtained.

In order to achieve the above-mentioned second object, a third liquid crystal alignment film of the present invention is a monomolecular film formed on the surface of the substrate which is provided with electrodes beforehand and on which a rubbing treatment is performed directly or after forming an arbitrary thin film. It is preferable in the above-mentioned liquid crystal alignment film that the molecules constituting the monomolecular film comprise carbon chains or siloxane bond chains, and a part of or the terminal of the carbon chain or the siloxane bond chain contains at least one functional group for controlling a surface energy of the film.

With such a structure, since the film is a monomolecular film, the thickness may be thin as the nano-meter level. The liquid crystal alignment film can be provided, where the orientation of liquid crystal can be controlled by rubbing and the pre-tilt angle of liquid crystal can be controlled by controlling the critical surface energy of the alignment film.

Furthermore, it is preferable in the above-mentioned liquid crystal alignment film that a plurality of types of silane-based surfactants each having a different critical surface energy are mixed and used as the molecules constituting the film, and the fixed film is controlled so as to have a desired critical surface energy. This is convenient in controlling the pre-tilt angle of liquid crystal.

Furthermore, it is preferable in the above-mentioned liquid crystal alignment film that the functional group for controlling the surface energy is at least one organic group selected from the group consisting of a carbon trifluoride group (—CF₃), a methyl group (—CH₃), a vinyl group (—CH═CH₂), an allyl group (—CH═CH—), an acetylene group (carbon-carbon triple bonds), a phenyl group (—C₆H₅), a phenylene group (—C₆H₄—), a halogen atom, an alkoxy group (—OR; R represents an alkyl group. In particular, alkyl group having 1 to 3 carbon atoms is preferred.), a cyano group (—CN), an amino group (—NH₂), a hydroxyl group (—OH), a carbonyl group (═CO), a carboxy group (—COO—) and a carboxyl group (—COOH). This is advantageous because the critical surface energy can easily be controlled. Moreover, it is preferable that the critical surface energy of the film is controlled in the predetermined value ranging from 15 mN/m to 56 mN/m, and thus the pre-tilt angle of the injecting liquid crystal optionally can be controlled in the range from 0° to 90°.

Furthermore, it is preferable in the above-mentioned liquid crystal alignment film that the molecules constituting the film contain Si at the terminals. This is advantageous because the molecules easily can be fixed to the surface of the substrate.

In order to achieve the above-mentioned second object, a third method for producing the liquid crystal alignment film of the present invention is characterized by comprising the steps of performing a rubbing treatment on the surface of the substrate provided with electrodes beforehand in the arbitrary direction directly or after forming an arbitrary protective film, and contacting the surface of the substrate with a chemisorption solution prepared by using a silane-based surfactant comprising carbon chains or siloxane bond chains, wherein a part of or the terminal of the carbon chain or the siloxane bond chain contains at least one functional group for controlling a surface energy of the film so as to cause a chemical reaction between the surfactant molecules in the chemisorption solution and the surface of the substrate, thereby fixing and bonding the surfactant molecules to the surface of the substrate at one end.

Such a method enables the production of the liquid crystal alignment film capable of constituting the liquid crystal display device having a high reliability in which the orientation of the liquid crystal can be controlled in the direction of rubbing and the pre-tilt angle of liquid crystal can be controlled by the surface energy.

It is preferable in the above-mentioned method for producing a liquid crystal alignment film that a silane-based surfactant containing linear carbon chains or siloxane bond chains and chlorosilyl groups or alkoxysilyl groups or isocyanate silyl groups is used as the surfactant. This is convenient for producing the monomolecular film.

Furthermore, it is preferable in the above-mentioned method for producing a liquid crystal alignment film that a plurality of types of silicon-based surfactants having different critical surface energies are mixed and used as the surfactant. This is advantageous because the critical surface energy of the film can be finely controlled and the pre-tilt angle of liquid crystal can be controlled.

Furthermore, it is preferable in the above-mentioned method for producing a liquid crystal alignment film that the terminal of or a part of the carbon chain or the siloxane bond chain comprises at least one organic group selected from the group consisting of a carbon trifluoride group (—CF₃), a methyl group (—CH₃), a vinyl group (—CH═CH₂), an allyl group (—CH═CH—), an acetylene group (carbon-carbon triple bonds), a phenyl group (—C₆H₅), a phenylene group (—C₆H₄—), a halogen atom, an alkoxy group (—OR; R represents an alkyl group. In particular, alkyl group having 1 to 3 carbon atoms is preferred.), a cyano group (—CN), an amino group (—NH₂), a hydroxyl group (—OH), a carbonyl group (═CO), a carboxy group (—COO—) and a carboxyl group (—COOH). This is advantageous because the critical surface energy can be controlled exactly.

Furthermore, it is preferable that the above-mentioned method for producing a liquid crystal alignment film further comprises, after the step of bonding and fixing the surfactant molecules to the surface of the substrate at one end, the steps of washing the substrate with an organic solvent and tilting the substrate in a desired direction so as to drain off the solvent, thereby aligning the fixed molecules in the direction in which the solvent was drained off. This is advantageous because the liquid crystal alignment film having a further excellent alignment property can be obtained.

Furthermore, it is preferable that the above-mentioned alignment film further comprises, after the step of aligning the molecules, the step of exposure through a polarizing film so as to realign the aligned molecules in a desired direction. This is advantageous because the alignment property can further be improved.

Furthermore, it is preferable in the above-mentioned alignment film that a silane-based surfactant containing linear carbon chains or siloxane bond chains and chlorosilyl groups or isocyanate silyl groups is used as the surfactant, and a nonaqueous organic solvent containing no water is used as the washing organic solvent. This is advantageous because a less defective monomolecular liquid crystal alignment film can be provided.

Furthermore, it is preferable in the above-mentioned method for producing an alignment film that a solvent containing an alkyl group, a carbon fluoride group or a carbon chloride group or a siloxane group is used as the nonaqueous organic solvent. This is convenient for draining off the solvent.

Furthermore, it is preferable that the above-mentioned method for producing a monomolecular liquid crystal alignment film further comprises, after the step of rubbing and before the step of fixing the surfactant molecules at one end, the step of forming a film containing a large number of SiO groups to form a monomolecular film via the film. Thus, a monomolecular liquid crystal alignment film having higher density can be obtained.

In order to achieve the above-mentioned second object, the third liquid crystal display apparatus is characterized in that a film is formed as an alignment film for liquid crystal on a surface which is provided with electrodes of at least one of two substrates provided with facing electrodes and on which a rubbing treatment is performed directly or after forming an arbitrary thin film, directly or indirectly via another film, the film being constituted by molecules containing carbon chains or siloxane bond chains, the terminal of or a part of the carbon chain or the siloxane bond chain containing at least one functional group for controlling a surface energy of the film; and liquid crystal is interposed between the two facing electrodes via the alignment film.

It is preferable in the above-mentioned liquid crystal display apparatus that the film is formed as an alignment film on each of the surfaces of the two substrates which is provided with the facing electrodes and on which rubbing has been performed. This is advantageous because a liquid crystal display apparatus having a higher contrast can be obtained.

Furthermore, it is preferable in the above-mentioned liquid crystal display apparatus that the film on the surface of the substrate comprises a plurality of patterned sections, each having a different alignment direction. It is convenient because the angle of visibility can be remarkably improved.

Furthermore, the above-mentioned liquid crystal display apparatus efficiently can be applied to an inplane switch (IPS) system display apparatus in which facing electrodes are provided on one surface of the substrate.

A third method for producing a liquid crystal display apparatus is characterized by comprising the steps of performing a rubbing treatment on the surface of a first substrate including a first electrode group arranged in a matrix array beforehand directly or after forming an arbitrary film; contacting the surface of the substrate with a chemisorption solution prepared by using a silane-based surfactant comprising carbon chains or siloxane bond chains, wherein at least a part of or the terminal of the carbon chain or the siloxane bond chain contains at least one functional group for controlling a surface energy of the film so as to cause a chemical reaction between the surfactant molecules in the chemisorption solution and the surface of the substrate, thereby fixing and bonding the surfactant molecules to the surface of the substrate at one end; tilting the substrate in a desired direction so as to drain off the solvent, thereby aligning the fixed molecules in the direction in which the solvent was drained off; attaching the first substrate including the first electrode group to a second substrate or a second substrate including second electrode or electrode group in a manner in which the faces provided with the electrodes are facing inward with a predetermined gap while adjusting the position; and injecting predetermined liquid crystal between the first substrate and the second substrate. With such a production method, the above-mentioned liquid crystal display apparatus can be produced efficiently.

It is preferable that the above-mentioned method for producing the liquid crystal display apparatus further comprises the step of exposure to light polarized in a desired direction through a polarizing plate so as to align the orientations of the surfactant molecules in a specific direction at a desired tilt after the step of aligning the fixed molecules. This is advantageous because the liquid crystal display apparatus that is excellent in alignment property can be obtained.

Furthermore, in the method for producing a liquid crystal display apparatus, in the step of exposure to light polarized in a desired direction through a polarizing plate so as to align the orientations of the bonded surfactant molecules in a specific direction at a desired tilt, the step of exposure with a patterned mask disposed on the polarizing plate is performed several times, thereby forming a plurality of patterned sections each having a different alignment direction on one face of the alignment film. This makes it possible to provide a liquid crystal display apparatus having multi-domain alignment.

In order to achieve the above-mentioned second object, a fourth liquid crystal alignment film of the present invention is characterized in that a liquid crystal alignment film is a monomolecular film formed on the surface of the substrate provided with predetermined electrodes, wherein rubbing is performed on the surface of the film. It is preferable in the above-mentioned liquid crystal alignment film that the molecules constituting the film have carbon chains or siloxane bond chains, and the terminal of or a part of the carbon chain or the siloxane bond chain contains at least a functional group for controlling a surface energy of the film.

With such a structure, the liquid crystal alignment film is a monomolecular film in which the film thickness thin such as the nano-meter level, the alignment direction of liquid crystal is controlled by rubbing and the pre-tilt angle of liquid crystal can be controlled by controlling the critical surface energy of liquid crystal alignment film can be obtained.

Furthermore, it is preferable in the above-mentioned liquid crystal alignment film that a plurality of types of silicone-based surfactants each having a different critical surface energy are mixed and used as the molecules constituting the film, and the fixed film is controlled so as to have a desired critical surface energy. This is convenient in arbitrarily controlling the pre-tilt angle of the injected liquid crystal.

Furthermore, it is preferable in the above-mentioned liquid crystal alignment film that the functional groups for controlling the surface energy is at least one organic group selected from the group consisting of a carbon trifluoride group (—CF₃), a methyl group (—CH³), a vinyl group (—CH═CH₂), an allyl group (—CH═CH—), an acetylene group (carbon-carbon triple bonds), a phenyl group (—C₆H₅), a phenylene group (—C₆H₄—), a halogen atom, an alkoxy group (—OR; R represents an alkyl group. In particular, alkyl group having 1 to 3 carbon atoms is preferred.), a cyano group (—CN), an amino group (—NH₂), a hydroxyl group (—OH), a carbonyl group (═CO), a carboxy group (—COO—) and a carboxyl group (—COOH). This is advantageous because this makes it possible to control the critical surface energy easily. Moreover, it is preferable that the surface energy of the film is controlled to a desired value in the range from 15 mN/m to 56 mN/m. By controlling the critical surface energy by this way, the pre-tilt angle of the injected liquid crystal can be controlled optionally in the range from 0° to 90°.

Furthermore, it is preferable in the above-mentioned liquid crystal alignment film that the molecules constituting the film contain Si at the terminals. This makes it possible to fix the molecules to the surface of the substrate easily.

In order to achieve the above-mentioned second object, a fourth method for producing a liquid crystal alignment film is characterized in that a monomolecular liquid crystal alignment film is produced by the method comprising the steps of contacting the surface of the substrate with a chemisorption solution prepared by using a silane-based surfactant comprising carbon chains or siloxane bond chains, wherein at least a part of or the terminal of the carbon chain or the siloxane bond chain contains at least one functional group for controlling a surface energy of the film so as to cause a chemical reaction between the surfactant molecules in the chemisorption solution and the surface of the substrate, thereby fixing and bonding the surfactant molecules to the surface of the substrate at one end; and rubbing the surface.

It is preferable in the above-mentioned method for producing a liquid crystal alignment film that a silane-based surfactant containing linear carbon chains or siloxane bond chains and chlorosilyl groups, or alkoxysilane groups or isocyanate silane groups is used as the surfactant. This is advantageous in producing monomolecular films.

Furthermore, it is preferable in the above-mentioned method for producing a liquid crystal alignment film that a plurality of types of silicon-based surfactants having different critical surface energies are mixed and used as the surfactant. This is advantageous because the surface energy of the film can be finely controlled and the pre-tilt angle of liquid crystal can be precisely controlled.

Furthermore, it is preferable in the above-mentioned method for producing a liquid crystal alignment film that a terminal of or a part of the carbon chain or the siloxane bond chain comprises at least one organic group selected from the group consisting of a carbon trifluoride group (—CF₃), a methyl group (—CH₃), a vinyl group (—CH═CH₂), an allyl group (—CH═CH—), an acetylene group (carbon-carbon triple bonds), a phenyl group (—C₆H₅), a phenylene group (—C₆H₄—), a halogen atom, an alkoxy group (—OR; R represents an alkyl group. In particular, alkyl group having 1 to 3 carbon atoms is preferred.), a cyano group (—CN), an amino group (—NH₂), a hydroxyl group (—OH), a carbonyl group (═CO), a carboxy group (—COO—) and a carboxyl group (—COOH). This is advantageous because the surface energy of the film can finely be controlled.

Furthermore, it is preferable that the above-mentioned method for producing a liquid crystal alignment film further comprises the steps of washing the surface of the substrate with an organic solvent after the step of bonding and fixing the surfactant molecules to the surface of the substrate at one end, tilting the substrate in a desired direction so as to drain off the solvent, thereby preliminarily aligning the fixed molecules in the direction in which the solvent was drained off, and then performing the rubbing. This is advantageous because the direction of the alignment film can be controlled more uniformly.

Furthermore, it is preferable in the above-mentioned method for producing a liquid crystal alignment film that after the rubbing is performed on the monomolecular film so as to orientate the aligned molecules in the predetermined direction, the step of exposure with a patterned mask disposed on the polarizing plate is performed, thereby forming a plurality of patterned sections each having a different alignment direction on one face of the alignment film. This is advantageous because the display performance of the device can further be improved.

Furthermore, it is preferable in the above-mentioned method for producing a liquid crystal alignment film that a silane-based surfactant containing linear carbon chains or siloxane bond chains and chlorosilyl groups or isocyanate silyl groups is used as the surfactant, and nonaqueous organic solvent containing no water is used as the washing organic solvent. This is advantageous because a less defective monomolecular film can be obtained.

Furthermore, it is preferable in the above-mentioned method for producing a liquid crystal alignment film that a solvent containing an alkyl group, a carbon fluoride group or a carbon chloride group or a siloxane group is used as the nonaqueous organic solvent. Thus, the solvent can be advantageously drained off.

Furthermore, it is preferable that the above-mentioned method for producing a liquid crystal alignment film further comprises the steps of forming a film containing a large number of SiO groups before the step of fixing the surfactant molecules at one end, forming the monomolecular film via the film and then performing rubbing.

In order to achieve the above-mentioned second object, a fourth liquid crystal display apparatus of the present invention is characterized in that a monomolecular film formed as an alignment film for liquid crystal directly or indirectly via other film on a surface provided with electrodes of at least one substrate of two substrates provided with facing electrodes, on which a rubbing treatment is performed, the film being constituted by molecules containing carbon chains or siloxane bond chains, the terminal of or a part of the carbon chain or the siloxane bond chain containing at least one functional group for controlling a surface energy of the film; and liquid crystal is interposed between the two facing electrodes via the alignment film. A liquid crystal display apparatus in which the thickness can be controlled in the nano-meter level, the direction of alignment of liquid crystal can be controlled and the pre-tilt angle of liquid crystal can be controlled by controlling the surface energy of the alignment film can be obtained.

It is preferable in the above-mentioned liquid crystal display apparatus that each of the film is formed as an alignment film on the surface of the substrate provided with two facing electrodes. Thus, the liquid crystal display apparatus having a high contrast can be obtained.

Furthermore, it is preferable in the above-mentioned liquid crystal display apparatus that the film on the surface of the substrate comprises a plurality of patterned sections each having a different alignment direction. This is advantageous because the angle of visibility can be remarkably improved.

Furthermore, the above-mentioned liquid crystal display apparatus is preferably used in an inplane switch (IPS) system where the counter electrodes are formed on one surface of the substrate.

According to a fourth method for producing a liquid crystal display apparatus of the present invention, a method comprises the steps of forming a direct or an arbitrary thin film on a first substrate including a first electrode group arranged in a matrix array beforehand; contacting the surface of the substrate with a chemisorption solution prepared by using a silane-based surfactant comprising carbon chains or siloxane bond chains, wherein at least a part of or the terminal of the carbon chain or the siloxane bond chain contains one functional group for controlling a surface energy of the film, so as to cause a chemical reaction between the surfactant molecules in the chemisorption solution and the surface of the substrate, thereby fixing and bonding the surfactant molecules to the surface of the substrate at one end; washing the substrate with an organic solvent, and then tilting the substrate in a desired direction so as to drain off the solvent, thereby preliminarily aligning the fixed molecules in the direction in which the solvent was drained off; rubbing the surface; fixing and attaching the first substrate having the first electrode group to a second substrate or a second substrate including second electrodes or electrode group in a manner in which the faces provided with the electrodes are facing inward with a predetermined gap while adjusting the position; and injecting predetermined liquid crystal between the first substrate and the second substrate. According to such a production method, the liquid crystal display apparatus that has an excellent display property can be produced effectively.

In the above-mentioned method for producing a liquid crystal display apparatus, after the above-mentioned surfactant molecules which was subjected to rubbing treatment and bonded to the surface of the substrate are aligned in the predetermined direction, the step of exposure with a patterned mask disposed on the polarizing plate, thereby forming a plurality of patterned sections each having a different alignment direction on one face of the alignment film.

### BRIEF DESCRIPTION OF DRAWINGS

FIG. 1 shows a state in which a surfactant molecule having a linear carbon chain and chlorosilane groups is chemically adsorbed to the surface of the substrate.

FIG. 2 shows a state in which the surfactant molecules chemically adsorbed to the surface of the substrate shown in FIG. 1 are bonded to each other.

FIG. 3 shows a first liquid crystal alignment film in one embodiment of the present invention.

FIG. 4 shows an example of a polymerization reaction of linear carbon chains in a first liquid crystal alignment film in one embodiment of the present invention.

FIG. 5 is a cross-sectional view illustrating the state in which a substrate is immersed in a chemisorption solution in a first method for producing a liquid crystal alignment film in one embodiment of the present invention.

FIG. 6 is a cross-sectional view illustrating the state in which the solvent is being drained off the substrate after the substrate is washed with organic solvent in a first method for producing a liquid crystal alignment film in one embodiment of the present invention.

FIG. 7 is a cross-sectional view illustrating a method for providing convexities and concavities on a transparent substrate for exposure in one embodiment of the present invention.

FIG. 8 is a cross-sectional view illustrating another method for providing convexities and concavities of a transparent substrate for exposure in one embodiment of the present invention.

FIG. 9 is a cross-sectional view illustrating a transparent substrate for exposure in one embodiment of the present invention.

FIG. 10 is a graph showing the relationship between the size of the convexities and concavities patterns and the degree of alignment order of the transparent substrate for exposure in one embodiment of the present invention.

FIG. 11 is a perspective view illustrating an exposing process in which a transparent substrate is used as a mask in a first method for producing a liquid crystal alignment film in one embodiment of the present invention.

FIG. 12 shows a first transparent substrate provided with a first liquid crystal alignment film in one embodiment of the present invention.

FIG. 13 is a cross-sectional view illustrating a first liquid crystal display apparatus in one embodiment of the present invention.

FIG. 14 is a cross-sectional view illustrating a process in which a film is exposed to light via a mask for exposure in a second method for producing a liquid crystal alignment film in one embodiment of the present invention.

FIG. 15 is a cross-sectional view illustrating a transparent substrate provided with a second liquid crystal alignment film in one embodiment of the present invention.

FIG. 16 is a cross-sectional view illustrating a second liquid crystal display apparatus in one embodiment of the present invention.

FIG. 17 is a cross-sectional view illustrating the state in which a substrate is immersed in a chemisorption solution in a third method for producing a liquid crystal alignment film in one embodiment of the present invention.

FIG. 18 is a cross-sectional view illustrating the state in which the solvent is drained off the substrate after the substrate is washed with organic solvent in a third manufacturing method for producing a liquid crystal alignment film in one embodiment of the present invention.

FIG. 19 shows a third liquid crystal alignment film in one embodiment of the present invention.

FIG. 20 is a perspective view illustrating a method in which exposure is performed via a polarization film.

FIG. 21 is a view illustrating a transparent substrate provided with a third liquid crystal alignment film in one embodiment of the present invention.

FIG. 22 shows a third liquid crystal alignment film in one embodiment of the present invention.

FIG. 23 is a view illustrating a state in which a chlorosilane monomolecular film is formed (before a reaction with moisture in the air) in a third method for producing a liquid crystal alignment film in one embodiment of the present invention.

FIG. 24 shows a state in which a siloxane monomolecular film is formed in a third method for producing a liquid crystal alignment film in one embodiment of the present invention.

FIG. 25 is a cross-sectional view illustrating a third liquid crystal display apparatus in one embodiment of the present invention.

FIG. 26 is a cross-sectional view illustrating the state in which a substrate is immersed in a chemisorption solution in a fourth method for producing a liquid crystal alignment film in one embodiment of the present invention.

FIG. 27 is a cross-sectional view illustrating the state in which the solvent is being drained off the substrate after the substrate is washed with organic solvent in a fourth method for producing a liquid crystal alignment film in one embodiment of the present invention.

FIG. 28 shows a fourth liquid crystal alignment film in one embodiment of the present invention.

FIG. 29 is a perspective view illustrating a process in which exposure is performed via a polarization film in a fourth method for producing a liquid crystal alignment film of the present invention.

FIG. 30 shows a transparent substrate provided with a fourth liquid crystal alignment film in one embodiment of the present invention.

FIG. 31 shows a fourth liquid crystal alignment film in one embodiment of the present invention.

FIG. 32 is a view illustrating a state in which a chlorosilane monomolecular film is formed (before a reaction with moisture in the air) in a method for producing the fourth liquid crystal alignment film in one embodiment of the present invention.

FIG. 33 is a view illustrating a state in which a siloxane monomolecular film is formed in a fourth method for producing a liquid crystal alignment film in one embodiment of the present invention.

FIG. 34 is a cross-sectional view illustrating a fourth liquid crystal display apparatus in one embodiment of the present invention.

### BEST MODE FOR CARRYING OUT THE INVENTION

The first liquid crystal alignment film of the present invention comprises surfactant molecules having linear carbon chains fixed to the surface of the substrate at one end. Such a surfactant molecule may include a surfactant molecules comprising at least one substituent group selected from the group consisting of a carbon trifluoride group (—CF₃), a methyl group (—CH₃), a vinyl group (—CH═CH₂), an allyl group (—CH═CH—), an acetylene group (carbon-carbon triple bonds), a phenyl group (—C₆H₅), an phenylene group (—C₆H₄—), a halogen atom, an alkoxy group (—OR; R represents an alkyl group. In particular, an alkyl group having 1 to 3 carbon atoms is preferred.), a cyano group (—CN), an amino group (—NH₂), a hydroxyl group (—OH), a carbonyl group (═CO), a carboxy group (—COO—), a carboxyl group (—COOH), and isocyanate group (—NCO). A surfactant molecule having substituent groups selected from the group consisting of chlorosilane groups, alkoxysilane groups and isocyanate silane groups at the terminals is preferably used as the surfactant molecule.

Furthermore, a surfactant molecule having a photopolymerization functional group such as a diacetylene group, an acetylene group or the like in its linear carbon chain is preferably used as the surfactant molecules having a linear carbon chain. More specifically, the following surfactant molecules (1) to (6) are preferred.

CH₃(CH₂)ₚ—C≡C—C≡C—(CH₂)_{q}SiCl₃ (1)

CN(CH₂)ₚ—C≡C—C≡C—(CH₂)_{q}SiCl₃ (2)

(CH₃)₃Si—C≡C—(CH₂)ᵣSiCl₃ (3)

CH₃ (CH₂)ₚ—C≡C—C≡C—(CH₂)_{q}Si(OCH₃)₃ (4)

CH₃ (CH₂)ₚ—C≡C—C≡C—(CH₂)_{q}Si(NCO)₃ (5)

(CH₃)₃Si—C≡C—(CH₂)ᵣSi(OCH₃)₃ (6)

In the above-mentioned chemical formulae, p and q denote integers of 0 or more, preferably integers of 0 to 10; and r denotes an integer of 0 or more, preferably an integer of 2 to 24.

The surfactant molecules represented by the above formulae (1) to (6) are preferably used in combination with other types of surfactant molecules. In this case, the surfactant molecules represented by following formulae (7) to (20) can be used as other types of surfactant molecules.

CH₃(CH₂)ₙSiCl₃ (7)

CH₃ (CH₂)ₚSi(CH₃)₂(CH₂)_{q}SiCl₃ (8)

CH₃COO(CH₂)ₘSiCl₃ (9)

C₆H₅(CH₂)ₙSiCl₃ (10)

CN(CH₂)ₙSiCl₃ (11)

C₁₃Si(CH₂)ₛSiCl₃ (12)

Cl₃Si(CH₂)₂(CF₂)ₜ(CH₂)₂SiCl₃ (13)

Ha(CH₂)ᵤSi(OCH₃)₃ (14)

CH₃(CH₂)ₙSi(NCO)₃ (15)

CH₃(CH₂)ₚSi(CH₃)₂(CH₂)_{q}Si(OCH₃)₃ (16)

HOOC(CH₂)ₘSi(OCH₃)₃ (17)

H₂N(CH₂)ₘSi(OCH₃)₃ (18)

C₆H₅(CH₂)ₙSi(NCO)₃ (19)

CN(CH₂)ₙSi(OC₂H₅)₃ (20)

In the above-mentioned chemical formulae, Ha represents a halogen atom such as chlorine, bromine, iodine, fluorine or the like; m is an integer of 0 or more, preferably an integer of 7 to 24; n is an integer of 0 or more, preferably an integer of 1 to 24; s is an integer of 0 or more, preferably an integer of 3 to 24; t is an integer of 0 or more, preferably of an integer of 1 to 10; and u is an integer of 0 or more, preferably an integer of 1 to 24.

More specifically, the surfactant molecules represented by the following chemical formulae (21) to (45) can be used.

Br(CH₂)₈SiCl₃ (21)

CH₂═CH(CH₂)₁₇SiCl₃ (22)

CH₃(CH₂)₈—CO—(CH₂)₁₀SiCl₃ (23)

CH₃(CH₂)₅—COO—(CH₂)₁₀SiCl₃ (24)

CH₃(CH₂)₈—Si(CH₃)₂—(CH₂)₁₀SiCl₃ (25)

CH₃(CH₂)₁₇SiCl₃ (26)

CH₃(CH₂)₅Si(CH₃)₂ (CH₂)₈SiCl₃ (27)

CH₃COO(CH₂)₁₄SiCl₃ (28)

C₆H₅(CH2)₈SiCl₃ (29)

CN(CH₂)₁₄SiCl₃ (30)

Cl₃Si(CH₂)₈SiCl₃ (31)

C₁₃Si(CH2)₂(CF₂)₄(CH₂)₂SiCl₃ (32)

Cl₃Si(CH₂)₂(CF₂)₆(CH₂)₂SiCl₃ (33)

CF₃CF₂ (CF₂)₇(CH₂)₂SiCl₃ (34)

(CF₃)₂CHO (CH₂)₁₅Si(CH₃)₂Cl (35)

CF₃CF₂(CH₂)₂Si(CH₃)₂(CH₂)₁₅SiCl₃ (36)

CF₃(CF₂)₄(CH₂)₂Si (CH3)₂(CH₂)₉SiCl₃ (37)

CF₃(CF₂)₇(CH₂)₂Si(CH₃)₂(CH₂)₉SiCl₃ (38)

CF₃COO(CH₂)₁₅SiCH₃Cl₂ (39)

CF₃(CF₂)₅(CH₂)₂SiCl₃ (40)

CH₃CH₂C*HCH₃CH₂OCO(CH₂)₁₀SiCl₃ (41)

CH₃CH₂C*HCH₃CH₂OCOC₆H₄OCOC₆H₄O(CH₂)₅SiCl₃ (42)

ClSi(CH₃)₂OSi(CH₃)₂OSi(CH₃)₂OSi(CH3)₂Cl (43)

Cl₃SiOSi(CH₃)₂OSi(CH₃)₂OSi(CH₃)₂OSi(CH₃)₂OSiCl₃ (44)

CH₃(CH₂)₈—C≡C—C≡C—(CH₂)₄SiCl₃ (45)

Herein, C* denotes an asymmetric carbon having an optical activity.

In a case where the surfactant molecules represented by the formulae (7) to (45) are used together with each other, it is preferable that the surfactant molecules of a shorter molecular length than the molecules of long molecular length having linear carbon chains that are polymerized with each other are selected.

The surfactant molecules are added in an organic solvent, preferably in a nonaqueous organic solvent to form a chemisorption solution. As the organic solvent, solvents containing an alkyl group, a carbon fluoride group, carbon chloride group, siloxane group, or the like, are be used. More specifically, it is preferable that hexadecane containing an alkyl group, freon containing a carbon fluoride group and/or a carbon chloride group, hexamethyldisiloxane containing a siloxane group, or the like, is used as a nonaqueous solvent so as to reduce the moisture content, thereby obtaining a uniform monomolecular film.

As a substrate with which the chemisorption solution is contacted, a transparent glass substrate and a resin substrate can be used. More specifically, various types of glass substrate, such as soda-lime silicate, borosilicate, aluminosilicate, or the like, and various types of resin substrate such as polyester film or the like can be used.

A series of chemical reactions caused when the chemisorption solution containing surfactant molecules are contacted with the surface of the substrate so as to form the film will be explained as follows. In the following, the surfactant is a silane-based surfactant represented by the above-mentioned chemical formula (1) and the hydrophilic group contained on the surface of the substrate is a hydroxyl group.

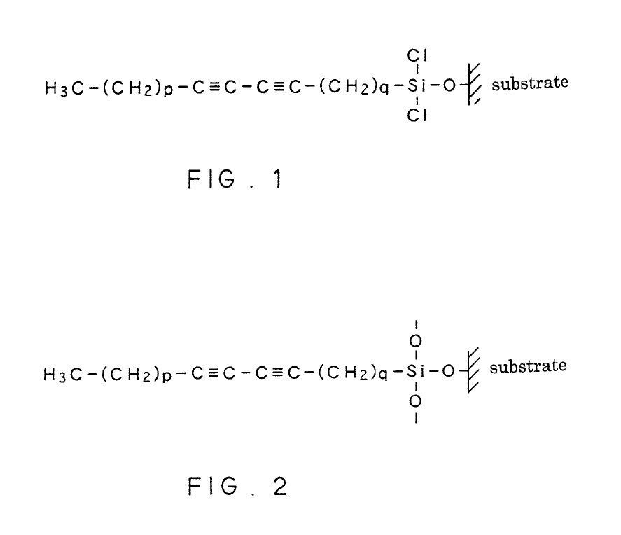

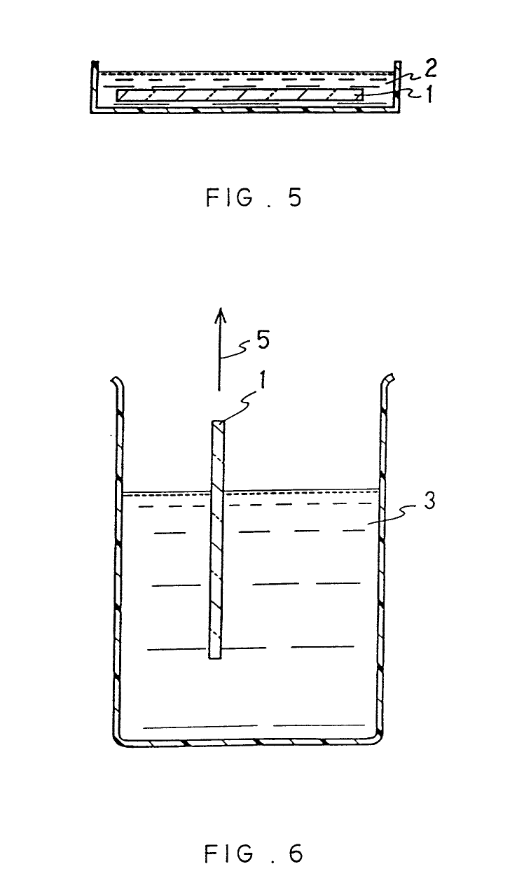

In this case, as shown in FIG. 5, when the chemisorption solution 2 is brought into contact with the surface of the substrate 1, dehydrochlorination reaction occurs between a chrolosilane group and a hydroxyl group, thereby fixing the surfactant molecules to the surface of the substrate via a siloxane bond as shown in FIG. 1.

Next, the substrate is lifted from the solution 2, washed with a nonaqueous solvent and exposed to the air containing moisture. Consequently, a dehydrochlorination reaction occurs between the surfactant molecules that are chemically adsorbed to the substrate and remained thereon even after washing and moisture in the air. As a result, as shown in FIG. 2, surfactant molecules are bonded to each other via siloxane bonds.

The film that is formed in such a process is a chemisorption monomolecular film comprising a group of molecules fixed to the surface of the substrate at one end. This group of molecules is bonded to the substrate via a siloxane bond and monomolecules are bonded with each other. Thus, the film exhibits an excellent property such as peeling resistance.

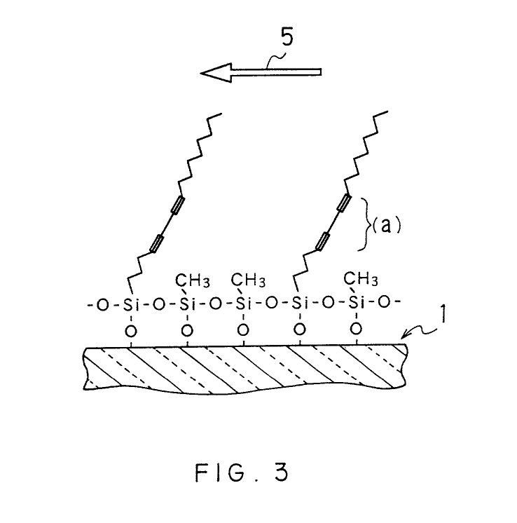

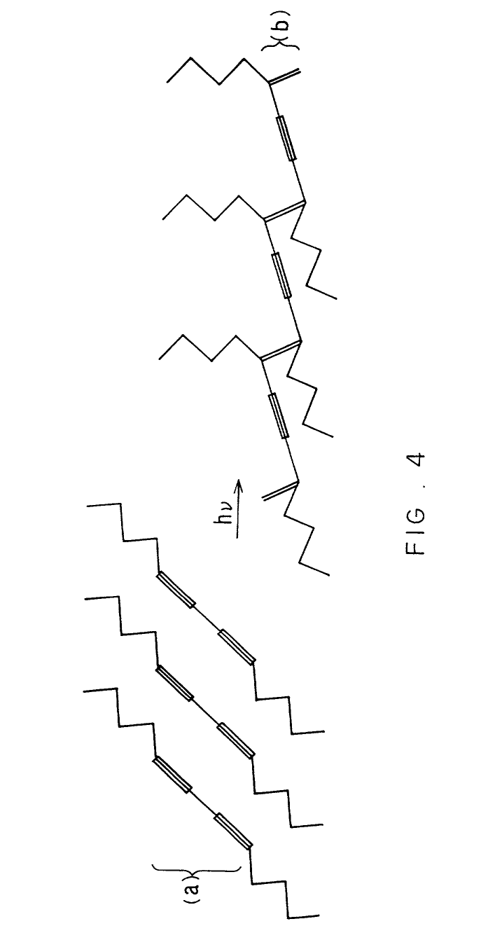

FIG. 3 is a cross-sectional view of the film enlarged to a molecular level. The film is formed by contacting a chemisorption solution comprising a surfactant molecule having a linear carbon chain having a diacetylene group (a) represented by formula (1) and a chlorosilane group at its terminal and CH₃SiCl₃ that is shorter molecule than the above-mentioned molecule with the substrate in the same manner as the above-mentioned method and then washing with a nonaqueous solution.

In FIG. 3, the tilt of the linear carbon chains with respect to the substrate is controlled at a constant angle due to the relatively short molecules. The precision of controlling the tilt can be enhanced by making the direction in which the nonaqueous solution is drained off the constant direction (the direction opposite to the direction 5 in which the substrate is lifted). Moreover, the film itself shown in FIG. 3, in which the tilt of the linear carbon chains with respect to the substrate is controlled, has an alignment regulation force with respect to liquid crystal. One aspect of the present invention is that the alignment regulation force of such a liquid crystal alignment film is further improved.

As shown in FIG. 3, the linear carbon chain whose tilt with respect to the substrate is controlled contains a diacetylene group. The diacetylene group can be polymerized while exhibiting a constant regularity when the polymerization is performed by exposure. The regular polymerization is typically found in the polymerization in which diacetylene group (a) is added and polymerized to form polydiacetylene (b). The tilt angle of the linear carbon chain with respect to the substrate is changed due to the polymerization of the diacetylene group. Consequently, when the polymerization by exposure is selectively performed only in the predetermined region of the substrate, convexities and concavities, which were not present before polymerization, can be generated between the portion in which diacetylene group is polymerized and the portion in which diacetylene group is not polymerized. If this phenomenon is used, for example, a plurality of convexities and concavities, which are parallel to each other and extend in the constant direction, can be formed on the surface of the film. The convexities and concavities extending in the same direction have highly precise sizes that are controlled at a molecular level. Thus, the convexities and concavities are efficient in improving the alignment regulation force with respect to liquid crystal.

In order to primarily align and to polymerize a linear carbon chain, it is preferable that the direction in which a nonaqueous solvent used for washing the substrate is drained off in the constant direction. For example, in a case where the substrate is drained off after the substrate is immersed in the nonaqueous solution is lifted, the substrate is lifted from the solution so that the surface of the substrate is parallel to the vertical direction as shown in FIG. 6. Like arrow 5 of FIG. 6, an arrow shown in FIG. 3 illustrates the direction in which the substrate is lifted. Needless to say, the method for draining off the solvent is not limited to the above-mentioned method alone. Other methods may be employed, for example, a method in which dried air or other gas is blown to the surface of the substrate from a constant direction to splash and remove the nonaqueous solvent in one direction. In this case, the direction in which the nonaqueous solvent is splashed and removed is the direction in which the solution is drained off.

As the solvent for washing the substrate, a nonaqueous solvent that is similar to the above-mentioned organic solvent is preferred. Examples of such a solvent include a nonaqueous solution containing a solvent containing an alkyl group, a carbon fluoride group, a carbon chloride group, a siloxane group, or the like. Although it is not particularly limited, specific examples include n-hexane, Freon 113, chloroform, hexamethyldisiloxane, or the like.

As the translucent substrate used for exposing the film to light, a substrate on which a plurality of grooves having a width and depth of 0.01 to 0.5 μm are formed parallel with each other is preferably used. In the translucent substrate having such convexities and concavities, such convexities and concavities patterns per se can provide liquid crystal with an alignment property. Thus, the alignment regulation force with respect to the liquid crystal can be improved by transferring the above-mentioned convex and concave patterns via such a translucent substrate by exposure.

In a case where the exposure is performed via such a translucent substrate, it is preferable that the translucent substrate is positioned so that the direction in which convexities and concavities on the surface extend is not orthogonal to the direction in which the nonaqueous solvent is drained off.

As materials of the translucent substrate, various types of glass and resins may be used. Specifically, soda-lime silicate glass, silica glass, polycarbonate resins, acrylic resins, or the like can be used. In a case where, for example, resins such as polycarbonate resins, acrylic resins, or the like, are used as the substrate, the convexities and concavities on the surface of the translucent substrate can be formed by rubbing the surface thereof with a rubbing cloth that has been conventionally used for producing a liquid crystal alignment film. Furthermore, in a case where the glass substrate is employed, the convexities and concavities can be formed by forming a resist film on the surface of the glass substrate, exposing thereof to light so as to form predetermined patterns, and developing thereof. Moreover, if the substrate is further etched by the method of chemical etching, plasma etching, sputter etching, or the like, after the convexities and concavities are formed, the aspect ratio of the grooves of convexities and concavities can preferably be increased.

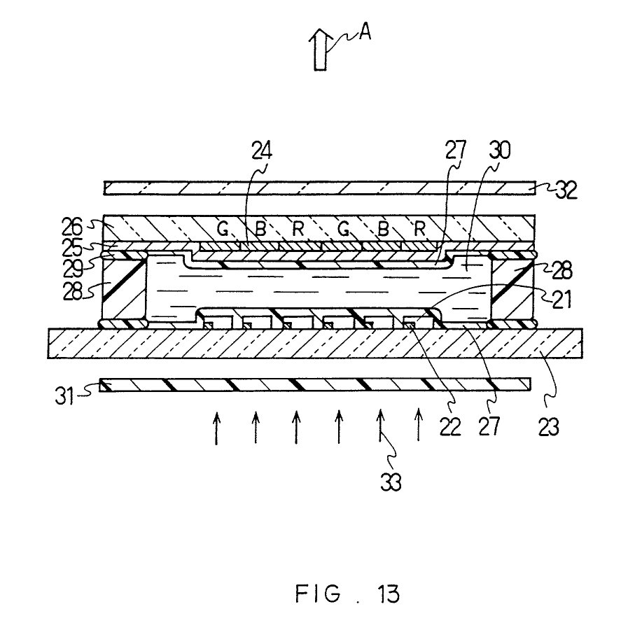

FIG. 13 shows a first liquid crystal display apparatus in one embodiment of the present invention. This liquid crystal display apparatus comprises a first substrate 23 and a second substrate 26. The first substrate 23 is provided with a first electrode group 21 arranged in a matrix array and a transistor group 22 for driving the electrodes. The second substrate 26 has a second electrode 25 and a color filter group 24. The first substrate 23 and the second substrate 26 are positioned so that the first electrode group 21 etc. of the first substrate 23 and a color filter group 24 are facing each other, and the first and second substrates are fixed with spacers 28 and adhesives 29. A first liquid crystal alignment film 27 of the present invention is formed on the surface including the region provided with electrodes, thin film transistors, color filters, or the like, on the surface on which the first substrate 23 and the second substrate 26 are facing. The liquid crystal alignment films 27 are formed in such a manner in which they cover the above-mentioned electrodes, etc. and liquid crystal 30 is interposed therebetween, thus providing liquid crystal 30 with the alignment property. In addition, on both sides of a panel comprised of the substrates 23 and 26, polarizing plates 31 and 32 are located in such a manner that they surround this panel. The device structured in this way displays images in the direction shown by arrow A by being entirely irradiated with back light 33 from the first substrate and by driving each transistor with video signals.

In such a liquid crystal display apparatus, the alignment direction of the liquid crystal alignment film 27 is not controlled by a mechanical contacting means such as rubbing but is controlled by a means including exposure as mentioned above. Therefore, in the liquid crystal display apparatus, local ununiformity of the alignment direction of liquid crystal due to the presence of step portions on the surface or a large area panel can be inhibited.

The second liquid crystal alignment film of the present invention is a film provided with convexities and concavities by the step of exposure. As materials of such a liquid crystal alignment film, a photosensitive resin can be suitably used. As the photosensitive resin, a resin that changes in the molecular structures, for example, photocrosslinkage, photomodification, photopolymerization, photodissociation, or the like, can be used. However, a resin that is usable as a photoresist is preferred. Specifically, a resin including photosensitive polyimide is preferred.

As the substrate, a transparent glass substrate or a resin substrate may be used. More specifically, various kinds of glass substrates such as soda-lime silicate, borosilicate, aluminosilicate, or the like, and various kinds of resin substrate such as polyester film, or the like, may be used. The film can be formed by applying the above-mentioned photosensitive resin to the surface of such a substrate.

Furthermore, as materials of a liquid crystal alignment film, photosensitive surfactant can be used. Such a surfactant includes the surfactant having a linear carbon chain comprising a photopolymerization functional group, for example, a diacetylene group, an acetylene group, or the like. Specifically, the surfactants mentioned as examples of the materials of the first liquid crystal alignment film of the present invention is usable. In a case where such a surfactant is used, the second liquid crystal alignment film can employ substantially the same embodiment as that mentioned as the first liquid crystal alignment film. However, the second liquid crystal alignment film is not always required to be a monomolecular film.

In a case where such a surfactant is used, as explained in the first liquid crystal alignment film of the present invention, the photopolymerization functional group contained in the linear carbon chain is polymerized by exposure. If the polymerization by exposure is selectively performed only in the predetermined region on the substrate, in the portion between the portion in which the photopolymerization functional group is polymerized and the portion in which the photopolymerization functional group is not polymerized, convexities and concavities, which were not present before polymerization, can be generated. If this phenomenon is used, a plurality of convexities and concavities extending in the constant direction can be formed on the surface of the film. The convexities and concavities extending in the same direction are highly precise in which the sizes are controlled at a molecular level. Thus, the convexities and concavities are efficient in improving the alignment regulation force with respect to liquid crystal.

As the translucent substrate used as a mask when the film is exposed to light, a substrate on which a plurality of grooves having the width and depth of 0.01 to 0.5 μm are formed in such a manner in which they are parallel with each other is preferred. In the translucent substrate having such convexities and concavities, the patterns of convexities and concavities per se can provide liquid crystal with an alignment property. Thus, the alignment regulation force with respect to liquid crystal can further be improved by transferring the above-mentioned patterns of convexities and concavities via such a translucent substrate. Such a translucent substrate for exposure can be produced by the same materials and the same method as those mentioned in the embodiment of the first liquid crystal alignment film.

FIG. 16 shows a second liquid crystal display apparatus in one embodiment of the present invention. This liquid crystal display apparatus has substantially the same structure as the first liquid crystal display apparatus of the present invention except that a second liquid crystal alignment film of the present invention is employed for a liquid crystal alignment film 127. In the liquid crystal display apparatus, the convexities and concavities of the liquid crystal alignment film 127 are not formed by a mechanical contacting means such as rubbing but formed by a means including exposure as mentioned above. Therefore, in the obtained liquid crystal display apparatus, local ununiformity of the alignment of liquid crystal due to the presence of step portions on the surface or large area panel can be inhibited.

The third liquid crystal alignment film of the present invention is characterized in that the film is a monomolecular film formed on a surface of a substrate which is provided with electrodes beforehand and on which a rubbing treatment is performed directly or after forming an arbitrary thin film. As an arbitrary thin film capable of being formed on the surface of the substrate includes, for example, SiO₂ film. Furthermore, rubbing can be performed by using the conventionally rubbing cloth of common use.

As the substrate, a transparent glass substrate or a resin substrate can be used. More specifically, various kinds of glass substrates, such as, soda-lime silicate, borosilicate, aluminosilicate, or the like, and various kinds of resin substrates, such as polyester film can be used.

Moreover, it is preferable that the substrate is subjected to a treatment for increasing the number of hydrophilic groups present on its surface. As a treatment, for example, a treatment for forming a film provided with a large number of SiOH groups on the surface of the substrate can be employed. Such a film can be formed by the steps of preparing an adsorption solution by dissolving a compound containing a plurality of chlorosilyl groups, and contacting the surface of the substrate with this adsorption solution. The mechanism of forming the film will be explained by taking an example where SiCl₄ is used as the compound including chlorosilyl groups. The molecules including chlorosilane groups are fixed to the surface of the substrate via siloxane bonds as shown in the following chemical formula (46) and/or (47) after a dehydrochlorination reaction between hydroxyl groups contained on the surface of the substrate and chlorosilyl groups of SiCl₄.

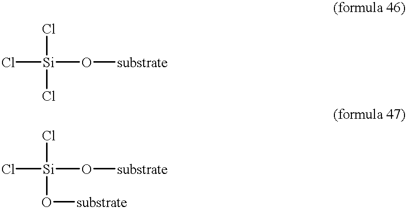

Furthermore, chlorosilyl groups reacted with moisture in the air are changed into hydroxyl groups, so that a chemisorption film comprising a large number of hydroxyl groups on its surface is formed as shown in the following chemical formula (48) and/or (49).

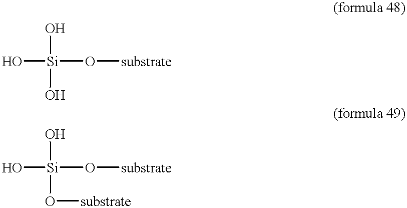

Examples of the compound containing a plurality of chlorosilyl groups include SiCl₄, Cl—(SiCl₂O)₂—SiCl₃, SiHCl₃, SiH₂Cl₂, Cl—(SiCl₂O)ₙ—SiCl₃ (n is an integer), or the like.

As materials of the liquid crystal alignment film, the surfactant molecules comprising a carbon chain or a siloxane bond chain, and containing a functional group capable of controlling the surface energy of the film on its part can be used. An example of the functional group capable of controlling the surface energy includes at least one organic group selected from the group consisting of a carbon trifluoride group (—CF₃), a methyl group (—CH₃), a vinyl group (—CH═CH₂), an allyl group (—CH═CH—), an acetylene group (carbon-carbon triple bonds), a phenyl group (—C₆H₅), a phenylene group (—C₆H₄—), a halogen atom, an alkoxy group (—OR; R represents an alkyl group. In particular, alkyl group having 1 to 3 carbon atoms is preferred.), a cyano group (—CN), an amino group (—NH₂), a hydroxyl group (—OH), a carbonyl group (═CO), a carboxy group (—COO—) and a carboxyl group (—COOH), or hydrocarbon group having an optical activity.

As the surfactant molecules used as the materials of liquid crystal alignment film, molecules comprising a carbon chain having a substitutent group selected from the group consisting of a chlorosilane group, an alkoxysilane group and an isocyanate silane group at its terminal or a siloxane bond chain is preferred.

As the surfactant molecules containing a carbon chain having a chlorosilane group at its terminal, compounds represented by the following chemical formulae (50) to (57) can be used.

Ha (CH₂)ₙSiCl₃ (50)

(Ha represents a halogen atom such as chlorine, bromine, iodine, fluorine, or the like, and n is an integer, preferably of 1 to 24)

CH₃(CH₂)ₙSiCl₃ (51)

(n is an integer, preferably of 0 to 24.)

CH₃(CH₂)ₚSi(CH₃)₂(CH₂)_{q}SiCl₃ (52)

(p and q are integers, preferably of 0 to 10.)

CH₃COO(CH₂)ₘSiCl₃ (53)

(m is an integer, preferably of 7 to 24.)

C₆H₅ (CH₂)ₙSiCl₃ (54)

(n is an integer, preferably of 0 to 24.)

CN(C H₂)ₙSiCl₃ (55)

(n is an integer, preferably of 0 to 24.)

Cl₃Si(CH₂)ₙSiCl₃ (56)

(n is an integer, preferably of 3to 24.)

Cl₃Si(CH₂)₂(CF₂) ₙ(CH₂)₂SiCl₃ (57)

(n is an integer, preferably of 1 to 10.)

As the surfactant molecules containing a carbon chain having an alkoxysilyl group or an isocyanate silyl group at its terminal, there are compounds represented by the following chemical formulae (58) to (64).

Ha(CH₂)ₙSi(OCH₃)₃ (58)

(Ha represents a halogen atom such as chlorine, bromine, iodine, fluorine, or the like; and n is an integer, preferably of 1 to 24.)

CH₃(CH₂)ₙSi(NCO)₃ (59)

(n is an integer, preferably of 0 to 24.)

CH₃(CH₂)ₚSi(CH₃)₂(CH₂)_{q}Si(OCH₃)₃ (60)

(p and q are integers, preferably of 0 to 10.)

HOOC(CH₂)ₘSi(OCH₃)₃ (61)

(m is an integer, preferably of 7to 24.)

H₂N(CH₂)ₘSi(OCH₃)₃ (62)

(m is an integer, preferably of 7to 24.)

C₆H₅(CH₂)ₙSi(NCO)₃ (63)

(n is an integer, preferably of 0 to 24.)

CN(CH₂)ₙSi(OC₂H₅)₃ (64)

(n is an integer, preferably of 0 to 24.)

More specifically, the compounds represented by the chemical formulae (65) to (88) can be used.

Br(CH₂)₈SiCl₃ (65)

CH₂═CH(CH₂)₁₇SiCl₃ (66)

CH₃(CH₂)₈—CO—(CH₂)₁₀SiCl₃ (67)

CH₃(CH₂)₅—COO—(CH₂)₁₀SiCl₃ (68)

CH₃(CH₂)₈—Si(CH₃)₂—(CH₂)₁₀SiCl₃ (69)

CH₃(CH₂)₁₇SiCl₃ (70)

CH₃(CH₂)₅Si(CH₃)₂(CH₂)₈SiCl₃ (71)

CH₃COO(CH₂)₁₄SiCl₃ (72)

C₆H₅(CH₂)₈SiCl₃ (73)

CN(CH₂)₁₄SiCl₃ (74)

Cl₃Si(CH₂)₈SiCl₃ (75)

Cl₃Si(CH₂)₂(CF₂)₄(CH₂)₂SiCl₃ (76)

Cl₃Si(CH₂)₂(CF₂)₆(CH₂)₂SiCl₃ (77)

CF₃CF₂(CF₂)₇(CH₂)₂SiCl₃ (78)

(CF₃)₂CHO(CH₂)₁₅Si(CH₃)₂Cl (79)

CF₃CF₂(CH₂)₂Si(CH₃)₂(CH₂)₁₅SiCl₃ (80)

CF₃(CF₂)₄(CH₂)₂Si(CH₃)₂(CH₂)₉SiCl₃ (81)

CF₃(CF₂)₇(CH₂)₂Si(CH₃)₂(CH₂)₉SiCl₃ (82)

CF₃COO(CH₂)₁₅SiCH₈Cl₂ (83)

CF₃(CF₂)₅(CH₂)₂SiCl₃ (84)

CH₃CH₂C*HCH₃CH₂OCO(CH₂)10SiCl₃ (85)

(C* represents an optically active asymmetric carbon.)

CH₃CH₂C*HCH₃CH₂OCOC₆H₄OCOC₆H₄O(CH₂)₅SiCl₃ (86)

(C* represents an optically active asymmetric carbon.)

CH₃(CH₂)₈—C≡C—(CH₂)₁₀SiCl₃ (87)

CH₃(CH₂)₈C≡C—C≡C—(CH₂)₁₀SiCl₃ (88)

As the surfactant molecules comprising a siloxane bond chain comprising a chlorosilyl group, an alkoxysilane group or an isocyanate silane group at its terminal, compounds represented by the following chemical formulae (89) to (90) can be used.

ClSi(CH3)₂OSi(CH₃)₂OSi(CH₃)₂OSi(CH₃)₂Cl (89)

Cl₃SiOSi(CH₃)₂OSi(CH₃)₂OSi(CH₃)₂OSi(CH₃)₂OSiCl₃ (90)

Furthermore, the surface energy of alignment film can be controlled by mixing and using a plurality of surfactants each having different surface energy as the surfactant for the liquid crystal alignment film material.

The surfactant molecules are added into an organic solvent, preferably a nonaqueous organic solvent to form a chemisorption solution. As the organic solvent, the solvent containing an alkyl group, a carbon fluoride group, a carbon chloride group and a siloxane group can be used. More specifically, it is preferable for obtaining a uniform monomolecular film that hexadecane containing an alkyl group, freon containing a carbon fluoride group and/or carbon chloride group, methyldisiloxane containing siloxane group, or the like, can be used as a nonaqueous solvent so as to reduce the moisture content.

The film is formed on the surface of the substrate by contacting this chemisorption solution with the surface of the substrate and causing a chemical reaction between the surfactant molecules and the surface of the substrate. A series of chemical reactions will be explained by taking the case where the surfactant molecule is a silane-based surfactant represented by the above-mentioned chemical formula (51) and the hydrophilic group on the surface of the substrate is a hydroxyl group as an example.

When the chemisorption solution is brought into contact with the surface of the substrate, dehydrochlorination reaction is caused between a chlorosilane group and a hydroxyl group. As a result, the surfactant molecules are fixed to the surface of the substrate via siloxane bonds as shown in the following chemical formula (91).

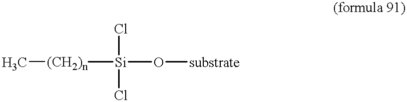

Next, when the substrate is lifted from the solution and then exposed to the air containing moisture, a dehydrochlorination reaction is generated between the surfactant molecules chemically adsorbed to the surface of the substrate and moisture in the air, thereby generating the siloxane bond as shown in the following chemical formula (92).

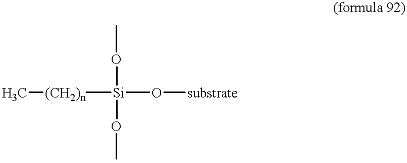

The film formed by such a step is a chemisorption monomolecular film comprising a group of molecules fixed to the surface of the substrate at one end. This group of molecules is bonded to the substrate via siloxane bonds and each of monomolecules is bonded to each other. Thus, the obtained film has an excellent property such as peeling resistance.

The method for contacting the adsorption film with the substrate, the method in which the substrate is immersed in the adsorption solution can be employed. Furthermore, in a case where the film is desired to be selectively formed, the method of printing the adsorption solution on the surface of the substrate in the predetermined patterns by the use of printing machine, or the method in which the surface of the substrate is covered with resist beforehand, and then the chemically adsorption step is performed onto the entire surface and then resist is removed, or the like, can be used. In this case, since the chemically adsorbed film is not peeled off by the organic solvent, it is preferable that the resist capable of removing the solvent by organic solvent is used.

Moreover, it is preferable that after the substrate is brought into contact with adsorption solution so as to fix the surfactant molecules, the substrate is washed with an organic solvent and the solution is drained off the substrate by tilting the substrate in the predetermined direction. Thus, the surfactant molecules fixed to the substrate are made to be aligned in the direction in which the solvent was drained off, thereby improving the alignment property of the liquid crystal alignment film. Any nonaqueous organic solvents containing no water and capable of dissolving the surfactant can be used as the washing organic solvent. In particular, a nonaqueous solvent containing an alkyl group, a carbon fluoride group, a carbon chloride group, a siloxane group, or the like, can preferably be used as the nonaqueous organic solvent. Although it is not particularly limited, specifically, n-hexane, Freon 113, chloroform, hexamethylenediamine, hexamethyldisiloxane, or the like, can be used.

Furthermore, the surfactant molecules fixed to the surface of the substrate can be realigned by exposing the substrate to light through a polarizing film. Moreover, at this time, in order to align the orientations of the molecules in one direction after the realignment of the molecules, it is desired to deviate the polarizing direction by some degrees, preferably more than several degrees, instead of allowing the polarizing direction to cross the lifting direction exactly at 90°. In this case, at the maximum, the polarizing direction may be arranged so as to be parallel to the direction before the realignment. If they cross exactly at 90°, each molecule may be oriented in two directions. Furthermore, in a case where the alignment direction is desired to be selectively changed, the method comprising the step in which the desired mask is disposed on the polarizing plate and then exposed to light is performed several times. With such a method, a monomolecular liquid crystal alignment film having a multi-domain in which the alignment film is different in patterns can be easily produced.

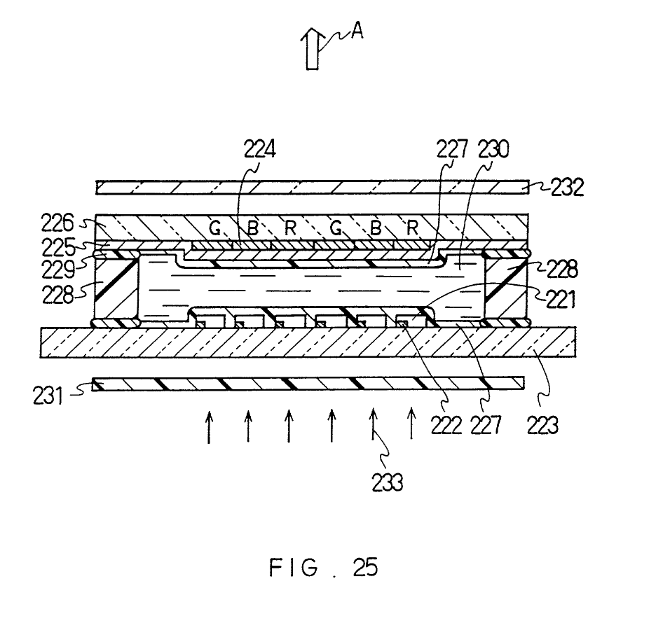

FIG. 25 shows a third liquid crystal display apparatus in one embodiment of the present invention. This liquid crystal display apparatus comprises a first substrate 223 and a second substrate 226. The first substrate 223 is provided with a first electrode group 221 arranged in a matrix array and a transistor group 222 for driving the electrodes. The second substrate 226 has a second electrode 225 and a color filter group 224. The first substrate 223 and the second substrate 226 are positioned so that the first electrode group 221 etc. of the first substrate 223 and a color filter group 224 are facing each other, and the first and second substrates are fixed with spacers 228 and adhesives 229. A first liquid crystal alignment film 227 of the present invention is formed on the surface including the region provided with electrodes on the surface, thin film transistors, color filters, or the like, on which the first substrate 223 and the second substrate 226 are facing. The liquid crystal alignment films 227 are formed in such a manner in which they cover the above mentioned electrodes, etc. with liquid crystal 30 interposed therebetween, thus providing liquid crystal 230 with the alignment property. In addition, on both sides of a panel comprised of the substrates 223 and 226, polarizing plates 231 and 232 are located in such a manner in which they interpose this panel. The device structured in this way displays images in the direction shown by arrow A by being entirely irradiated with back light 233 from the first substrate and by driving each transistor with video signals.

In such a liquid crystal display apparatus, the alignment direction of liquid crystal 230 is controlled in the rubbing direction. Furthermore, the pre-tilt angle of liquid crystal 230 is controlled by the critical surface energy of the liquid crystal alignment film.

The fourth liquid crystal alignment film of the present invention is a monomolecular film provided with predetermined electrodes on the surface of the substrate, which is characterized in that rubbing treatment is performed on the surface of the film. In other words, while in the third liquid crystal alignment film, the rubbing is performed with respect to the surface of the substrate before the film constituting the liquid crystal alignment film is formed, in the fourth liquid crystal alignment film, instead, the rubbing is performed with respect to the surface of the film after the film constituting the liquid crystal alignment film is formed.

The fourth liquid crystal alignment film can be formed of the same materials and by the same methods as those of the third liquid crystal alignment film of the present invention except for the rubbing step. Briefly speaking, as materials for forming a liquid crystal alignment film, silane-based surfactant comprising carbon chain or a siloxane bond chain and at least one functional group capable of controlling the surface energy of the film at the terminal or a part of the above mentioned carbon chain or siloxane bond chain can be used. As the method for producing the film, the method comprising the steps of preparing a chemisorption solution by using such a surfactant and fixing the surfactant molecule in the chemisorption solution to the surface of the substrate by contacting the surface of the substrate with the above-prepared chemisorption solution so as to cause a chemical reaction between the surfactant molecules having the linear carbon chain contained in the chemisorption solution with hydrophilic groups of the surface of the substrate may be employed. Furthermore, it is preferable that after the surfactant molecules are fixed to the surface of the substrate by contacting the substrate with adsorption solution, the substrate is washed with an organic solvent, and then the solvent is drained off the substrate by tilting the substrate in the desired direction.

As mentioned above, the surfactant molecules washed with an organic solvent after fixed to the surface of the substrate are aligned in the direction in which the washing organic solvent is drained off. In the fourth liquid crystal alignment film, the step of rubbing the surface of the surfactant film is performed, and thereby the surfactant molecules are aligned in the direction in which the rubbing is performed. Furthermore, as is similar to the third liquid crystal alignment film, the surfactant molecules fixed to the surface of the substrate can be realigned by exposing the surface of the substrate to light via the polarizing film. Moreover, rubbing can be performed by using a commonly-used rubbing cloth, etc.

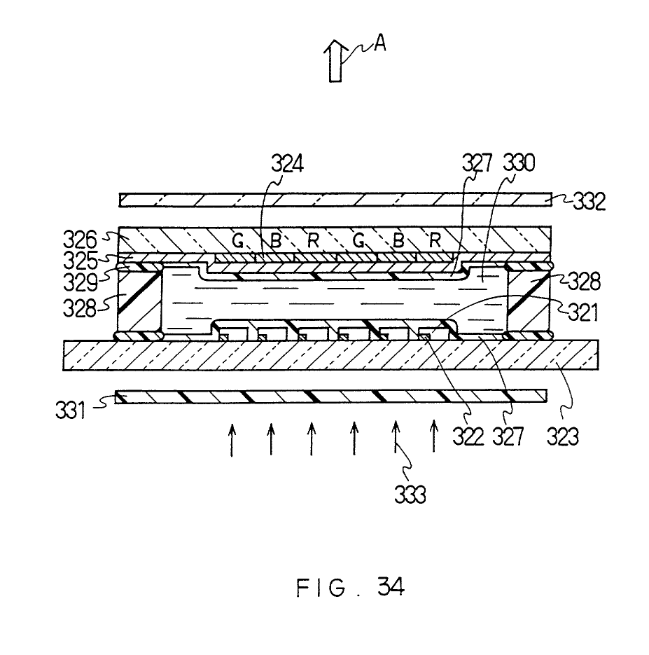

FIG. 34 shows a fourth liquid crystal display apparatus in one embodiment of the present invention. This liquid crystal display apparatus has substantially the same structure as the third liquid crystal display apparatus of the present invention except that a fourth liquid crystal alignment film of the present invention is employed for a liquid crystal alignment film 327. In this liquid crystal display apparatus, the alignment direction of liquid crystal 330 is controlled in the direction of rubbing. Furthermore, the pre-tilt angle of liquid crystal 330 is controlled by the critical surface energy of the liquid crystal alignment film.

### EXAMPLE 1

First, a translucent substrate suitable for a mask for exposure was prepared as follows.

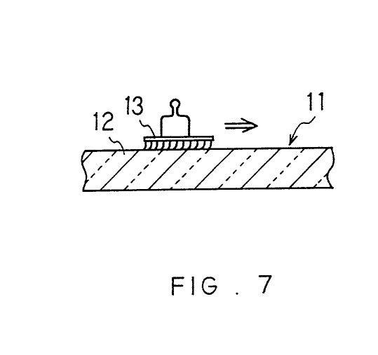

As shown in FIG. 7, a surface 11 of an acrylic transparent substrate 12, which had been ultrasonic cleaned with detergent, was subjected to a rubbing treatment. The rubbing was performed in the same direction by using a nylon cloth 13 (fiber diameter; 16 to 20 μm, fiber length; 3 mm) at the pushing depth of 0.4 mm and at the speed of 500 m/min. When the surface 11 of the substrate 12 was observed by using a scanning electron microscope, a large number of convexities and concavities oriented in the same direction were observed. The width and depth of the concave portion (groove portion) were approximately in the range from 0.01 to 0.5 μm. Thereafter, nematic liquid crystal (ZLI4792 manufactured by Merck & Co., Inc.) was applied to the surface of the transparent mask for exposure. As a result, it was confirmed that a liquid crystal was tidily aligned in the direction of rubbing, and the convexities and concavities had an effect of aligning liquid crystal.

Furthermore, when a polycarbonate plate was used as the substrate in place of an acrylic plate and was rubbed with a rubbing cloth for forming a liquid crystal alignment film in the same manner as mentioned above, the translucent substrate (mask for exposure) having convexities and concavities, which were oriented in approximately the same direction, a size in the range from 0.01 to 0.5 μm and having an effect of aligning liquid crystal was able to be formed.

For comparison, a translucent substrate was prepared by the same method except that Scotch sponge (manufactured by SUMITOMO 3M LIMITED) was used in place of a nylon cloth. A large number of convexities and concavities oriented in approximately the same direction were observed to be formed on the surface of the substrate. However, the light translucency was deteriorated. The width and depth of the groove portion formed on its surface were approximately in the range from 1 to 10 μm. Thereafter, when the above-mentioned nematic liquid crystal was applied to the surface of the substrate, liquid crystal partially aligned in the small groove portion of 0.5 μm or less where the grooves were formed in manner in which they were partially overlapped. However, in other portions on the surface, liquid crystal hardly aligned.

Furthermore, for comparison, convexities and concavities were formed by the same method as the above-mentioned example using the nylon cloth except that the pushing depth was 0.05 mm. In this case, the devertification of the acrylic plate was not observed at all and a small number of grooves oriented in the approximately the same direction were sparsely formed. The width and depth of the grooves were approximately in the range from 0.001 to 0.01 μm (1 to 10 nm). When the above-mentioned nematic liquid crystal was applied to the surface of this substrate, liquid crystal was aligned sparsely in the rubbing direction.

### EXAMPLE 2

Furthermore, a translucent substrate suitable for a mask for exposure was prepared by the following Example.

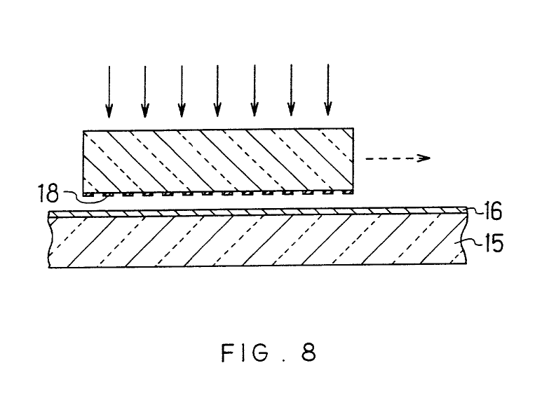

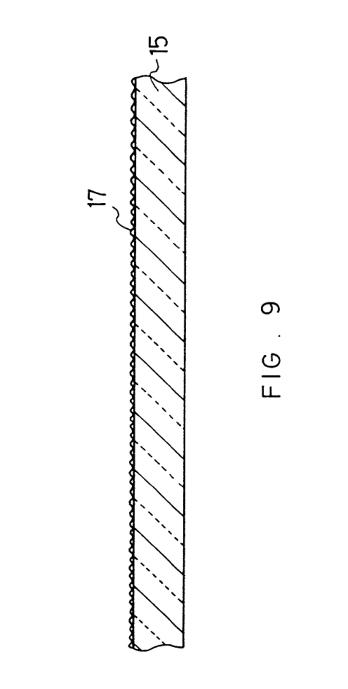

A resist film was produced by applying PDUR-P-14 as a resist (manufactured by Tokyo Ohka Kogyo Co., Ltd.) to the surface of an A4-size white glass substrate, which had been ultrasonic cleaned with detergent to the thickness of 0.5 μm. As shown in FIG. 8, the entire surface of this resist film 16 was exposed to light by repeating a step-and-repeat exposure (100 mJ/cm²) by a KrF excimer laser exposing apparatus by using a 5 cm×5 cm chrome mask 18 having 0.4 μm-wide monochrome pattern. In this exposure, the position of the mask was adjusted so that seam was overlapped in several mm. Thereafter, development was performed by using a developing solution NMD 3 (manufactured by Tokyo Ohka Kogyo Co., Ltd.) and rinsed with pure water. As a result, as shown in FIG. 9, a translucent substrate (mask for exposure) provided with a resist thin film 17 on the surface of the glass substrates was obtained. The resist film 17 had 0.4 μm-wide grooves (namely, 1250 diffraction gratings/nm), that is, convexities and concavities having a diffraction effect with respect to light. When nematic liquid crystal (ZLI4792 manufactured by Merck & Co., Inc.) was applied to the surface of the substrate, it was confirmed that liquid crystal was uniformly aligned along the line of patterns. Also, in the seam, liquid crystal was aligned as well.

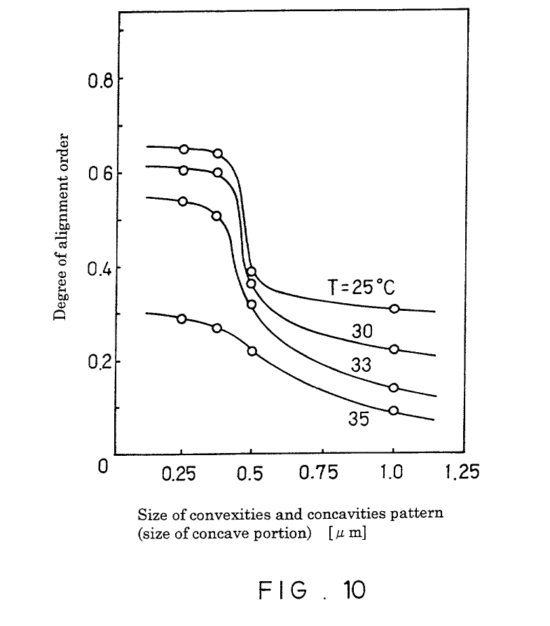

The same experiments were carried out several times except that a pattern pitch of the chrome mask to be transferred to the resist film was changed. The results are shown in FIG. 10. As is apparent from FIG. 10, it was confirmed that if the grooves having width and depth of 0.5 μm or less were formed in the same direction, the surface whose shape had an excellent alignment regulation force with respect to liquid crystal was obtained. Furthermore, in a case where the grooves of 0.01 μm or less were formed by a rubbing method, liquid crystal was observed to be aligned. However, it was difficult to form the grooves uniformly over the entire surface of the substrate, and thus it lacked the practical performance. Moreover, in FIG. 10, T denotes a temperature of each sample when the alignment film was examined.

When the same experiments were performed by using various types of substrate materials, it was confirmed that borosilicate glass, silica glass, polycarbonate resin, acrylic resin, or the like, were usable as the substrate. Furthermore, it was confirmed that as the light source for exposure so as to form the diffraction grading patterns of 0.5 μm or less, in place of Krf excimer laser, ultraviolet rays was usable. Furthermore, resist may be positive type or negative type as long as fine convexities and concavities were able to be formed.

Furthermore, after development, the substrate was subjected to a spatter etching using Ar gas or plasma etching using CF₄ gas to increase the depth of the grooves. Consequently, an aspect ratio of the grooves was able to be increased and alignment regulation force was able to be improved. Moreover, in a case where a glass plate or a silica plate was used for the substrate, the same results were able to be obtained by chemical etching with hydrofluoric acid based solution.

### EXAMPLE 3

Next, a liquid crystal alignment film was produced on a surface of a substrate by using the mask for exposure prepared in Example 1.

A glass substrate (comprising a large number of hydroxyl groups on its surface) provided with transparent electrodes on its surface was prepared, and washed and sufficiently degreased. Next, in a yellow room (a room for handling sensitive materials for sensitizing ultraviolet rays), by mixing silane-based surfactants represented by the following chemical formula (93) and CH₃SiCl₃ in a mole ratio of 1:2, and dissolving them into a nonaqueous solvent in a concentration of about 1 weight %, a chemisorption solution was prepared. As a solvent herein, sufficiently dehydrated hexadecane was used.

CH₃(CH₂)₈—C≡C—C≡C—(CH₂)₄SiCl₃ (formula 93)

As shown in FIG. 5, the glass substrate 1 was immersed in the chemisorption solution 2 in a dry atmosphere (a relative humidity of 30% or less) for about one hour. The glass substrate 1 was lifted from the chemisorption solution 2, washed with n-hexane 3, which was a sufficiently dehydrated nonaqueous solvent as shown in FIG. 6, lifted from the washing solution in a state in which the substrate was set vertically, and the solution was drained off in this state. In the series of steps, a chemisorption film having a thickness of about 2 nm was produced. Moreover, the adsorption solution may be applied to the glass substrate instead of immersing the glass in the adsorption solution.

The chemisorption solution provides a chemisorption monomolecular film formed by a dehydrochlorination reaction between chlorosilane groups contained in chlorosilane-based surfactant represented by the above-mentioned chemical formula (93) and CH₂SiCl₃ and hydroxyl groups on the surface of the glass substrate. The linear hydrocarbon chain contained in the monomolecular film is primarily oriented in the direction in which the nonaqueous solution was drained off as in FIG. 3.

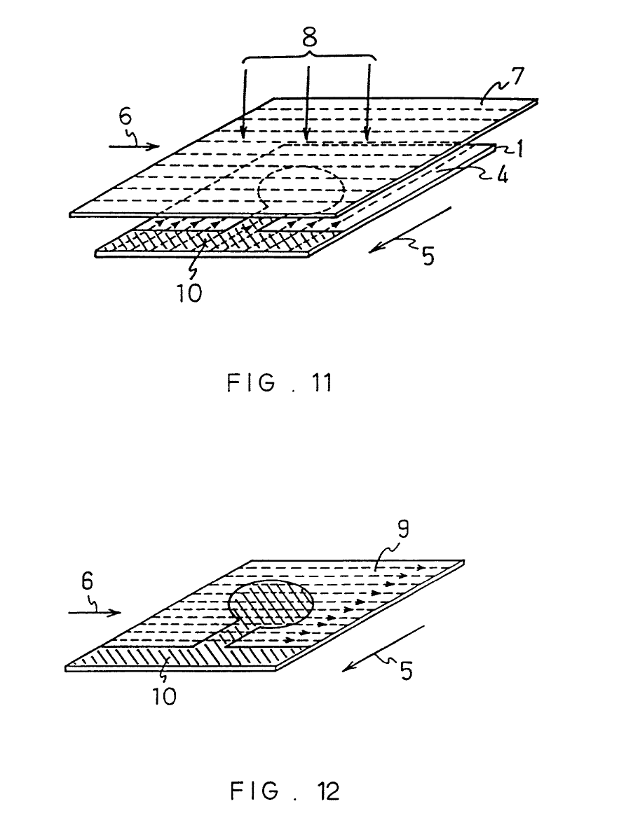

Thereafter, as shown in FIG. 11, a mask for exposure 7, which was the same mask as that prepared in Example 1, was positioned closely to the substrate so that the directions in which the substrate was lifted was substantially orthogonal but not exactly orthogonal to the direction 6 in which the rubbing was performed. The film was exposed to ultraviolet rays (UW light 8) of 365 nm at the intensity of about 200 mJ/cm². Patterns of the above-mentioned rubbing mask were transferred to the monomolecular film.

The surface of thus prepared monomolecular film was observed by using an AFM (atomic force scanning microscope). Consequently, as shown in FIG. 12, it was confirmed that a large number of convexities and concavities, which were oriented in the same direction, having a width of 0.01 to 0.5 μm and a depth of the molecular level were formed along the direction 6 in which the rubbing was performed on the mask.

Moreover, in the step of exposure of the mask 7 for exposure, the angle between the direction 5 in which the substrate was lifted and the direction 6 in which the rubbing was performed was variously changed. As a result, it was confirmed that convexities and concavities were formed as long as both directions were not exactly orthogonal to each other.

Furthermore, two substrates in this state were used and set so that the chemisorption films were facing each other. Thus, a liquid crystal cell of a 20 micron gap was assembled so that an anti-parallel orientation was obtained, and then the above-mentioned nematic liquid crystal was injected. When the orientation state was observed, the injected liquid crystal molecules were aligned substantially along the pattern of the above-mentioned chemically adsorbed monomolecular film at a pre-tilt angle of about 73° with respect to the substrate.

Furthermore, a monomolecular liquid crystal alignment film (namely, an alignment film for multi-domain alignment) having a different alignment direction was able to be produced easily in pattern by carrying out the step in which a desired mask was disposed on a mask for exposure and then exposed to light several times.

### EXAMPLE 4

Next, a liquid crystal display device was produced by using liquid crystal alignment film produced in Example 3.

First, a monomolecular liquid crystal alignment film was produced in the same manner as Example 3. As shown in FIG. 13, the monomolecular liquid crystal alignment film was produced on a first substrate provided with a first electrode group arranged in a matrix array and a transistor group for driving the electrodes and on a second substrate having a color filter group and a second electrode arranged so that they were facing the first electrode group.

Next, the first and the second substrates were positioned so that the first electrode and second electrode were facing each other, and fixed with spacers and an adhesive with about 5 micron gap. Thereafter, the above-mentioned TN liquid crystal was injected between the first and the second substrates, and then a polarizing plate was provided. Thus, a display device was completed.

Such a device was able to display images in the direction shown by arrow A by being entirely irradiated with back light and driving each transistor by using a video signal.

As in Example 4, by forming the films respectively on the surface of the substrate provided with two facing electrodes, a TN liquid crystal display apparatus can be provided. Furthermore, the method of this example was able to be applied not only to a TN liquid crystal display apparatus but also to an IPS (an inplane switching system) liquid crystal display apparatus provided with facing electrodes on one surface of the substrate.

### EXAMPLE 5

In the step of irradiation with light in Example 3, when the step of disposing a patterned mask for dividing each pixel into four sections in a checkerboard pattern on the above-mentioned mask for exposure was carried out twice while changing the direction of groove patterns, four sections each having a different alignment direction in a pattern were able to be formed in one pixel. Thus, when the substrate provided with this alignment film was used, the angle of visibility of the liquid crystal display apparatus was able to be remarkably improved.

### EXAMPLE 6

Another liquid crystal alignment film was formed on the surface of the substrate by using the mask for exposure produced in Example 2.

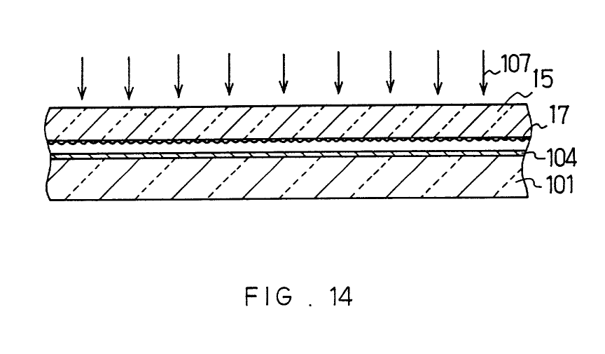

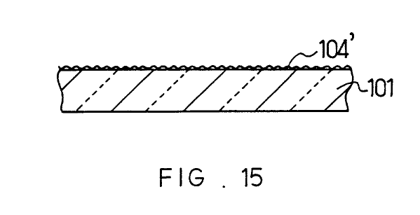

A borosilicate glass substrate provided with transparent electrodes on its surface was prepared, and washed and sufficiently degreased beforehand. Next, by applying a photosensitive polyimide resin (Photoneece manufactured by TORAY INDUSTRIES INC.) thereon to form a film having a thickness of 0.1 μm. Thereafter, as shown in FIG. 14, a film 104 on a glass substrate 101 was constantly exposed to light by irradiating with ultraviolet rays 107 of 365 nm at about 500 mJ/cm² via a mask for exposure 15 by the same method as Example 2. Furthermore, the film was developed with a special-purpose developing solution and rinsed with a special-purpose rinse, and the mask patterns of a mask 15 for exposure were transferred to a polyimide resin film. As shown in FIG. 15, the surface of thus formed polyimide resin film 104′ was provided with a large number of linear convexities and concavities being oriented parallel to each other. The pitch (cycle) of the convexities and concavities was about 0.8 μm (the width of each of convexities and concavities was about 0.4 μm) and the depth was about 0.05 μm.

When nematic liquid crystal was applied to the surface of the substrate, it was confirmed that liquid crystal was aligned along the pattern. Furthermore, two substrates in this state were used and set so that the chemisorption films were facing each other. Thus, a liquid crystal cell of a 20 micron gap was assembled so that an anti-parallel orientation was obtained, and then the above-mentioned nematic liquid crystal was injected. When the orientation state was observed, the injected liquid crystal molecules were aligned along the linear convexities and concavities at a pre-tilt angle of about 5° with respect to the substrate.

In this way, it was confirmed that when a photosensitive polymer was used as a material constituting the film and exposure development was performed via a mask having linear convexities and concavities patterns, in which the liquid crystal had been confirmed to be oriented, the patterns were transferred to the film surface to thus make a liquid crystal alignment film.

Moreover, even if the resin without having a photosensitivity was used, if the exposure time was increased by 10 to 100 times by using far ultraviolet rays of 248 nm from a KrF excimer laser, partial decomposition or polymerization occur on the surface of the resin. As a result, it was confirmed that the same fine convexities and concavities were formed and a film having the same alignment effect was formed.

### EXAMPLE 7

Another liquid crystal alignment film was formed on the surface of the substrate by using the mask for exposure prepared in Example 2.

The glass substrate (comprising a large number of hydroxyl groups on its surface) provided with transparent electrodes on its surface was prepared, and washed and sufficiently degreased. Next, in a yellow room, by mixing silane-based surfactants represented by the following chemical formula (94) and CH₃SiCl₃ in a mole ratio of 1:2, and dissolving them into a nonaqueous solvent in a concentration of the mixture of about 1 weight %, a chemisorption solution was prepared. As a solvent herein, sufficiently dehydrated hexadecane was used.

CH₃ (CH₂)₈—C≡C—C≡C—(CH₂)₄SiCl₃ (formula 94)

The glass substrate was immersed in the chemisorption solution in a dry atmosphere (a relative humidity of 30% or less) for about one hour. The glass substrate was lifted from the chemisorption solution, and then a chemisorption polymer film comprising surfactant molecules having diacetylene groups was formed on the surface of the substrate. Next, the same as Example 6, the above-mentioned chemisorption polymer film was exposed to light, developed, and rinsed. As a result, a film having an alignment regulation force with respect to liquid crystal that was the same as Example 6 was able to be obtained.

### EXAMPLE 8

Next, a liquid crystal display device was produced by using the liquid crystal alignment film formed in Example 6.

First, a monomolecular liquid crystal alignment film was produced in the same manner as Example 6. As shown in FIG. 16, the monomolecular liquid crystal alignment film was produced on a first substrate provided with a first electrode group arranged in a matrix array and a transistor group for driving the electrodes and on a second substrate having a color filter group and a second electrode arranged so that they are facing the first electrode group.

Next, the first and the second substrates were positioned so that the first and second electrodes were facing each other, and fixed with spacers and an adhesive with about 5 micron gap. Thereafter, the above-mentioned TN liquid crystal (ZLI4792 manufactured by Merck & Co., Inc.) was injected between the first and the second substrates, and then a polarizing plate was provided. Thus, a display device was completed.

Such a device was able to display images in the direction shown by arrow A by being entirely irradiated with backlight and driving each transistor by using a video signal.

As in Example 8, by forming the films respectively on the surface of the substrate provided with two facing electrodes, the TN liquid crystal display apparatus was able to be provided. Furthermore, the method of this example was able to be applied not only to TN liquid crystal display apparatus but also to an IPS (an inplane switching system) liquid crystal display apparatus provided with facing electrodes on one surface of the substrate.

### EXAMPLE 9

In the step of irradiation with light in Example 6, when the step of disposing a patterned mask for dividing each pixel into four sections in a checkerboard pattern on the above-mentioned mask for exposure was carried out twice while changing the direction of groove patterns, four sections each having a different alignment direction in a pattern were formed in one pixel. Thus, when the substrate provided with this alignment film was used, the angle of visibility of the liquid crystal display apparatus was able to be remarkably improved.

### EXAMPLE 10

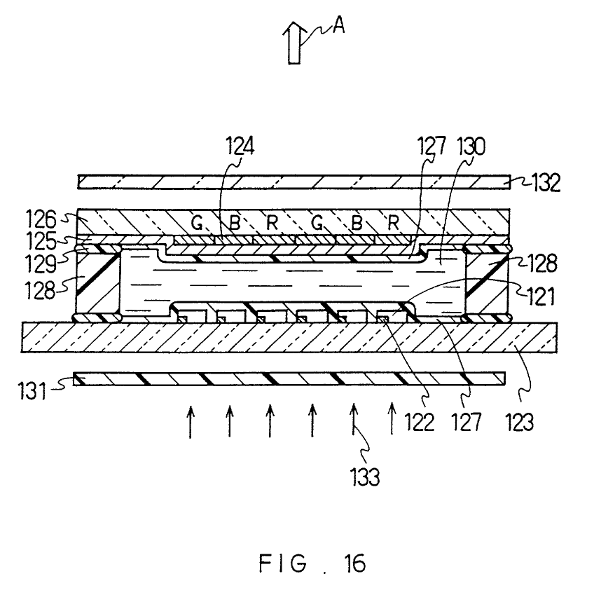

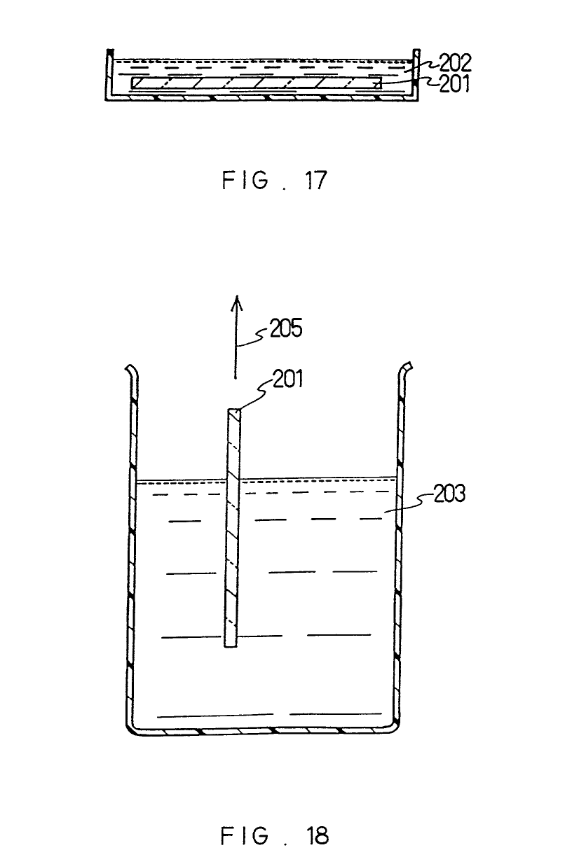

A glass substrate 201 (comprising a large number of hydroxyl groups on its surface) provided with transparent electrodes on its surface was prepared, and washed and sufficiently degreased beforehand. Then, SiO₂ protective film was formed to the thickness of about 0.1 μm by the sol-gel method, and heated and hardened. Thereafter, the surface was subjected to a rubbing treatment by using a rubbing cloth made of rayon generally used in common liquid crystal display device manufacture at pushing depth of 0.3 mm and at a speed of 80 m/minute in the desired alignment direction. Next, by using silane-based surfactants containing a linear hydrocarbon group comprising a functional group for controlling the surface energy of a film at the terminal and Si (hereinafter, referred to as a chemisorption compound), CH₃(CH₂)₁₄SiCl3 and NC(CH₂)₁₄SiCl₃ (mixed at a mole ratio of 1:1 and used), and dissolving them in a nonaqueous solvent in a concentration of about 1 weight %, a chemisorption solution was prepared. As the nonaqueous solvent, sufficiently dehydrated hexadecane was used. The thus prepared solution was used as an adsorption solution 202, and the above-mentioned substrate 201 was immersed in (may be coated with) the adsorption solution 202 in a dry atmosphere (a relative humidity of 30% or less) for about one hour (FIG. 17). Thereafter, the substrate was lifted from the adsorption solution, and washed with sufficiently dehydrated water-free n-hexane 203 that was a nonaqueous solvent containing no water. Then, the substrate was lifted from the washing solution and the solution was drained off, while being tilted in a desired direction (the direction in which the solution was drained off). Then the substrate was exposed to the air containing moisture (FIG. 18). In the series of steps, a dehydrochlorination reaction was caused between SiCl groups of the above-mentioned chlorosilane-based surfactant and hydroxyl groups on the surface of the substrate, thereby generating the bonds represented by the following formulae (95) and (96). In addition, a reaction with moisture in the air was caused, thereby generating the bonds represented by formulae (97) and (98).

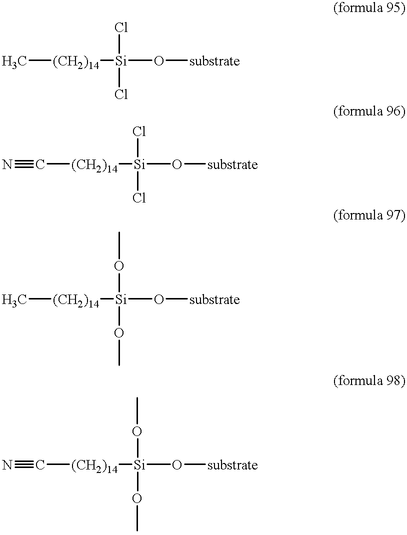

By performing the above-mentioned treatment, the chemisorption solution monomolecular film 204 formed by the reaction of the above-mentioned chlorosilane-based surfactants was formed to the thickness of about 1.5 nm in the portion of the surface of the substrate, on which the rubbing had been performed, comprising hydroxyl groups chemically bonded through covalent bonds of siloxane. Moreover, the critical surface energy of the chemisorption film at this time was about 27 mN/m. Furthermore, the linear hydrocarbon groups in a monomolecular film were aligned in the direction opposite to the direction in which the substrate was lifted from the solution (namely, the direction in which the solution was drained off).

In addition, two substrates in this state were used so as to be set so that the chemisorption films were facing each other. Thus, a liquid crystal cell of a 20-micron gap was assembled so that an anti-parallel orientation was obtained, and then nematic liquid crystal (ZLI4792 manufactured by Merck & Co., Inc.) was injected. When the orientation state was observed, the injected liquid crystal molecules were oriented approximately along the rubbing direction instead of orienting along the adsorbed molecules that had been preliminarily oriented. Furthermore, a pre-tilt angle was dependent on the surface energy of the chemically adsorbed molecules and was oriented at about 65° with respect to the substrate (FIG. 19).

Furthermore, when the composition of CH₃ (CH₂)₁₄SiCl₃ and NC(CH₂)₁₄SiCl₃ was changed in the range from 1:0 to 0: 1 (preferably, in the range from 10:1 to 1:50), the critical surface energy was changed from 20 mN/m to 29 mN/m, and only the pre-tilt angle was able to be controlled arbitrarily in the range from 90° to 40°, while the alignment direction was controlled in the rubbing direction. Furthermore, when a surfactant containing fluorine as a chemisorption compound, for example, CF3(CF₂)₅(CH₂)₂SiCl₃ was added, the critical surface energy was able to be reduced to 15 mN/m.

At this time, in the rubbing treatment, since SiO₂ protective film having higher hardness than that of, for example, commonly used polyimide resin, etc. was rubbed, so that the film was hardly harmed. Moreover, it was thought that the alignment direction was dependent on the rubbing direction because the monomolecular film was extremely thin, and molecular level convexities and concavities formed by rubbing of the basis protective film was not reduced by the monomolecular film. In other words, it was thought because rubbing effected on the surface of the monomolecular film, to thus determine the alignment direction. On the other hand, it was thought that the alignment direction was dependent on the types of monomolecular films because a surface energy was changed by depending on the types of the monomolecular films.

Moreover, in this example, the silane-based surfactants having a different critical surface energy for the obtainable film, and the same carbon chain length as —(CH₂)₁₄— were used. However, when the surfactants having a different carbon chain length (for example, —(CH₂)ₙ—; n is an integer of 1 to 30) were mixed and used, an alignment regulation force of the pre-tilt angle was able to be further enhanced.

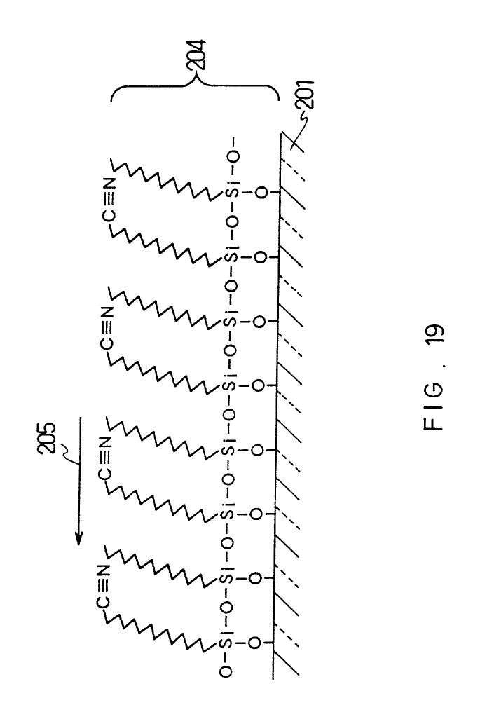

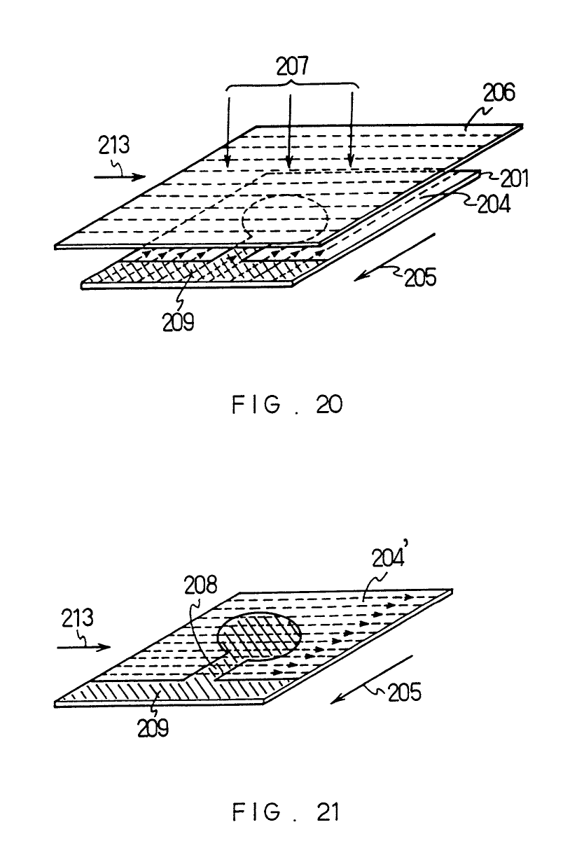

On the other hand, two similarly treated substrates in this state were used, and a polarizing plate (HNP′B) 206 (manufactured by POLAROID) was disposed on the substrate so that the polarizing direction 213 was substantially orthogonal to the lifting direction 205. Then, light 207 of 365 nm (i rays) (at 3.6 mW/cm² after passing through the polarizing plate) was radiated by using 500 W extra-high pressure mercury lamp at 950 mJ (FIG. 20).

In addition, two substrates in this state were used and set so that the chemisorption films were facing each other. Thus, a liquid crystal cell of a 20 micron gap was assembled so that an anti-parallel orientation was obtained in the irradiated portion, and then nematic liquid crystal (ZLI4792 manufactured by Merck & Co., Inc.) was injected. When the orientation state was observed, the injected liquid crystal molecules were aligned substantially along the rubbing direction in the portion in which the irradiation was not performed and the injected liquid crystal molecules were aligned substantially along the polarizing direction in the portion in which the irradiation was performed.

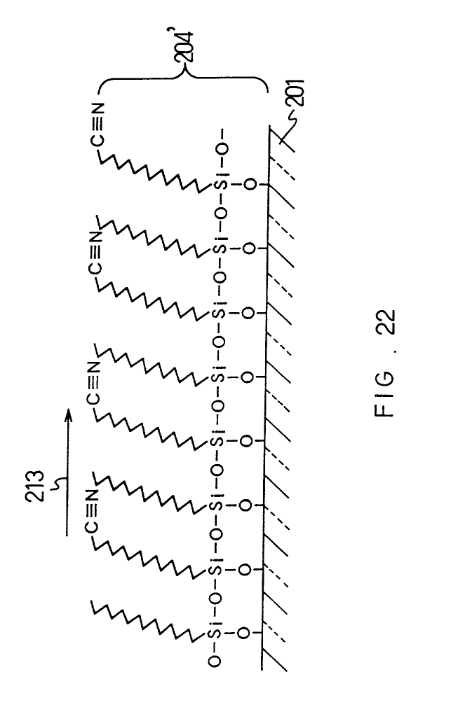

Furthermore, when the orientation direction in the linear carbon chain in the above-mentioned monomolecular chemisorption film 204′ was observed, the critical surface energy and tilt angle were not changed, however, the alignment direction 208 was changed in the direction approximately parallel to the polarizing direction 213 and not parallel to the direction 208 in which the substrate was drained off. In addition, the non-uniformity of the orientation was alleviated compared with the state after the substrate were lifted and drained off (FIGS. 21 and 22). Moreover, in the figures, numeral 209 denotes transparent electrodes.

Moreover, in the above-mentioned example, light of 365 nm, that is, i rays from an extra-high pressure mercury lamp was used as light for exposure. However, light of 248 nm obtainable from a KrF excimer laser, or light of 436 nm, 405 nm or 254 nm was able to be used, in accordance with the degree of absorption of light by a film substance. In particular, light of 248 nm or 254 nm exhibited high alignment efficiency because they were absorbed by most substances readily.

### EXAMPLE 11

Before the step of chemisorption of the surfactant molecules comprising carbon chains or siloxane bond chains in Example 10, an adsorption solution was prepared by dissolving a compound containing a plurality of chlorosilyl groups, and the substrate was immersed in the adsorption solution in a dry atmosphere. Then, a dehydrochlorination reaction was caused between hydroxyl groups contained on the surface of the substrate and chlorosilyl groups of the compound containing a plurality of chlorosilyl groups. Thereafter, when a reaction with water was followed, the remaining chlorosilyl groups were changed into hydroxyl groups, so that a chemisorption film comprising a large number of hydroxyl groups on its surface was formed.

For example, SiCl₄ was used as the silyl compound containing a plurality of chloro groups, and dissolved in n-octane, and thus an adsorption solution was prepared. Then, the substrate was immersed in the adsorption solution in a dry atmosphere. As a result, since —OH groups were contained on the surface, a dehydrochlorination reaction was caused at the interface so as to form the following formula (99) and/or formula (100). Thus, chlorosilane molecules 211 were fixed to the surface of the substrate via —SiO—bonds.

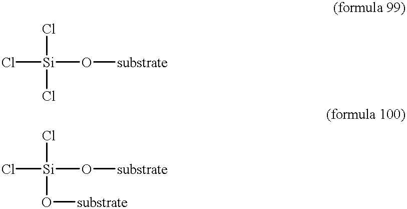

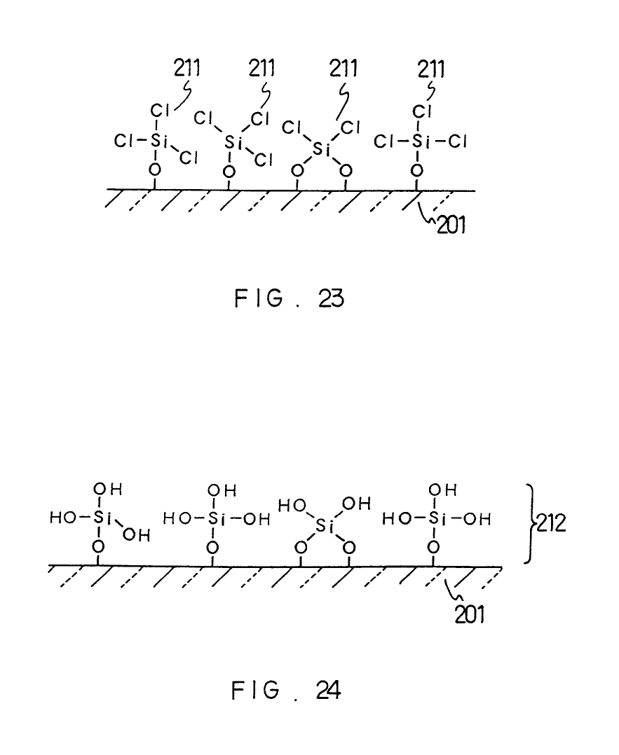

Thereafter, when the substrate was washed with a nonaqueous solvent such as chloroform, extra SiCl₄ molecules that had not reacted with the substrate were removed (FIG. 23). Furthermore, the substrate was taken out in the air so as to react with water. Then, a siloxane monomolecular adsorption film 212 containing a large number of SiO bonds represented by the following formula (101) and/or (102) was obtained on the surface (FIG. 24).

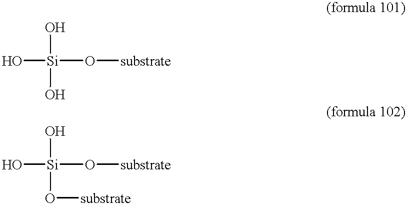

At this time, when the step of washing the substrate with a nonaqueous solvent such as chloroform was omitted, an extremely thin polysiloxane chemisorption film having a thickness of about 10 nm was formed.

Moreover, since the siloxane monomolecular film 212 formed in this way was completely bonded to the substrate via chemical bonds of —SiO—, it was not peeled off. Furthermore, the obtained monomolecular film has a large number of SiOH bonds on its surface. The SiOH bonds were generated in a number about twice or three times the original number of —OH groups. The treated portion in this state was highly hydrophilic.

In this state, when the chemisorption step was performed by using the same surfactant as Example 10, the same monomolecular chemisorption film comprising carbon chains formed as a result of the reaction of the same surfactant as in FIG. 19 was formed to a thickness of about 1.5 nm in a state of being chemically bonded through covalent bonds of siloxane via the above-mentioned siloxane monomolecular film 212. At this time, since the adsorption sites (OH groups in this case) on the surface of the substrate before adsorption of the surfactant were about twice or three times as many as that in Example 10, the density of the adsorbed molecules was able to be increased as compared with that of Example 10. The treated portion became lipophilic. Moreover, the molecules of the chemisorption film at this time, had a different molecular density but were aligned in the direction opposite to the lifting direction, namely, the direction in which the solution was drained off. Furthermore, the critical surface energy was 28 mN/m.

Two substrates in this state were used and set so that the chemisorption films were facing each other. Thus, a liquid crystal cell with a 20 micron gap was assembled so that an anti-parallel orientation was obtained, and then nematic liquid crystal (ZLI4792 manufactured by Merck & Co., Inc.) was injected. When the orientation state was observed, it was confirmed that the injected liquid crystal molecules to be aligned along the chemically adsorbed molecules and at a pre-tilt angle of about 46° with respect to the substrate.

In addition, another substrate after the solution was drained off was used, and a polarizing plate was disposed on the substrate so that the polarizing direction was substantially orthogonal to the lifting direction. Then, a half side of the substrate was irradiated with light of 248 nm from a KrF excimer laser at 800 mJ. Thereafter, when the orientation of the linear carbon chains in the monomolecular chemisorption film was examined, the aligning direction was changed in a direction substantially orthogonal to the lifting direction. In addition, ununiformity of the orientation was alleviated. Moreover, in the portion in which light was not irradiated, the alignment direction of the linear carbon chain was not changed from before the irradiation.

Then, two substrates in this state were used and set so that the chemisorption films were facing each other. Thus, a liquid crystal cell with a 20 micron gap was assembled so that an anti-parallel orientation was obtained, and then nematic liquid crystal (ZLI4792 manufactured by Merck & Co., Inc.) was injected and the orientation state was observed. In the portion in which the irradiation was not performed, the alignment direction was parallel to the rubbing direction and not changed from before irradiation. However, in the portion in which the irradiation was performed, the injected liquid crystal molecules were aligned along the polarization direction and at a pre-tilt angle of about 45° with respect to the substrate.

### EXAMPLE 12

In place of CH₃(CH₂)₁₄SiCl₃ and NC(CH₃)₂(CH₂)₁₄SiCl₃ in Example 10, in the case where ClSi(CH₃)₂OSi(CH₃)₂OSi(CH₃)₂OSi(CH₃)₂Cl and CH₃(CH₂)₁₄SiCl₃ were mixed in the range from 1:0 to 0:1 and used as the chemisorption material, the critical surface energy was able to be controlled in the range from 35 mN/m to 21 mN/m in accordance with the mixing ratio. When a cell was assembled and the same liquid crystal was injected, the alignment direction of liquid crystal was parallel to the robbing direction and the pre-tilt angle was able to be controlled in the range from 56 to 90°.

Furthermore, when ClSi(CH₃)₂OSi(CH₃)₂OSi(CH₃)₂OSi(CH₃)₂Cl comprising a linear siloxane bond chain was mixed with CH₃(CH₂)₁₄SiCl₃ comprising a linear hydrocarbon chain at a desired ratio so as to form a film, a monomolecular chemisorption film comprising the molecules represented by the following formula (103) and formula (104) in accordance with the mixing ratio was obtained.

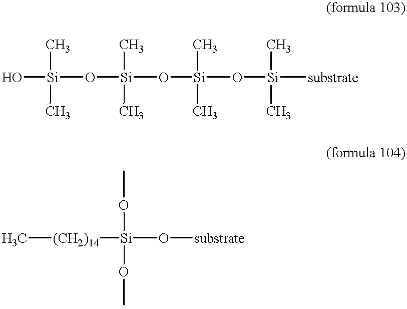

### EXAMPLE 13

In place of CH₃(CH₂)₁₄SiCl₃ and NC(CH₃)₂(CH₂)₁₄SiCl₃ in Example 10, HOOC(CH₂)₁₆Si(OCH₃)₃ and Br(CH₂)₈Si(OCH₃)₃ were mixed in the range from 1:0 to 0:1 and used as the chemisorption material, and reflux was performed at 100° C. for two hours during chemisorption. Also in this case, the critical surface energy was able to be controlled in the range from 56 mN/m to 31 mN/m in accordance with the mixing ratio.

Furthermore, when a cell was assembled and then the same liquid crystal was injected, the alignment direction of liquid crystal was parallel to the rubbing direction and the pre-tilt angle was able to be controlled in the range from 0° to 28°.

### EXAMPLE 14

In place of CH₃(CH₂)₁₄SiCl₃ and NC(CH₃)₂(CH2)₁₄SiCl₃ in Example 10, CH₃CH₂C*HCH₃CH₂ OCO(CH₂)₁₀SiCl₃ (wherein C* is an asymmetric carbon) and CH₃SiCl₃ were mixed in the range from 1:0 to 1:20 and used as the chemisorption material so as to produce the same alignment film. Also in this case, the critical surface energy was able to be controlled in the range from 36 mN/m to 41 mN/m in accordance with the mixing ratio. Furthermore, when a cell was assembled and then the same liquid crystal was injected, the alignment direction of liquid crystal was parallel to the rubbing direction and the pre-tilt angle was able to be controlled in the range from 3° to 0.1°.

### EXAMPLE 15

Next, a liquid crystal display device was actually produced by using the above-mentioned liquid crystal alignment film.

First, as shown in FIG. 25, a first substrate 223 provided with a first electrode group 221 arranged in a matrix array and a transistor group 222 for driving the electrodes and a second substrate 226 having a color filter group 224 arranged so that they were facing the first electrode group and a second electrode 225 were prepared. Then, according to the same procedures as in Example 14, the formation of a protective film, rubbing, chemical adsorption, and a step of draining off the washing solution were performed. Consequently, a chemisorption solution having a critical surface energy of 37 mN/m was produced.

Thereafter, the first substrate 223 and the second substrate 226 were positioned so that the electrodes were facing each other, and fixed with spacers 228 and an adhesives 229 with about 5 micron gap. Then, the above-mentioned TN system liquid crystal 230 was injected into the first and second substrates to be sealed, and then polarizing plates 231 and 232 were combined. Thus, a display device was completed. The pre-tilt angle of liquid crystal injected at this time was 3°. Furthermore, the alignment direction of liquid crystal was parallel to the rubbing, namely, parallel to an electrode pattern.

Such a device was able to display images in the direction shown by arrow A by being entirely irradiated with backlight 233 and by driving each transistor by using video signals.

### EXAMPLE 16

After the washing and lifting step in Example 15, when the step of irradiation with light in Example 11 by disposing a patterned mask for dividing each pixel into four sections in a checkerboard pattern was carried out once, four sections each having a different alignment direction in a mosaic pattern were able to be formed in one pixel. Thus, when the substrate provided with this alignment film was used, the angle of visibility of liquid crystal display apparatus was remarkably improved.

### EXAMPLE 17

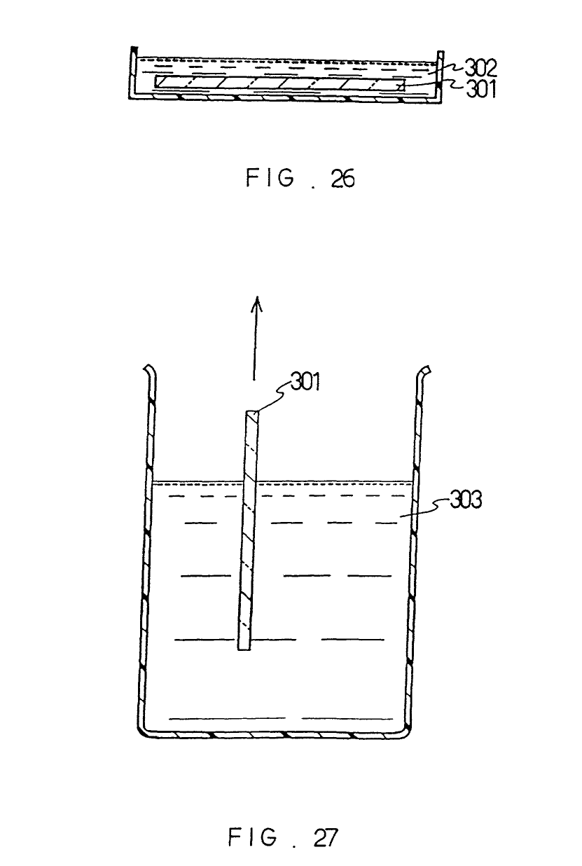

A glass substrate 301 (comprising a large number of hydroxyl groups on its surface) provided with transparent electrodes on its surface was prepared, and washed and sufficiently degreased beforehand. Next, by using CH₃(CH₂)₁₄SiCl₃ and NC(CH₂)₁₄SiCl₃ (mixed at a mole ratio of 1:1) as silane-based surfactants containing a linear hydrocarbon group comprising a functional group for controlling the surface energy of a film at the terminal and Si (hereinafter, referred to as a chemisorption material or chemisorption compound), and dissolving them in a nonaqueous solvent in a concentration of about 1 weight %, a chemisorption solution was prepared. As the nonaqueous solvent, sufficiently dehydrated hexadecane was used. The solution prepared in this way was defined as an adsorption solution 302, and the substrate 301 was immersed in (or may be coated with) this adsorption solution 302 in a dry atmosphere (a relative humidity of 30% or less) for about one hour (FIG. 26). Thereafter, the substrate was lifted from the solution, and washed with sufficiently dehydrated n-hexane 303, which is a nonaqueous solution and contains no water. Then, the substrate was lifted from the washing solution while being tilted in a desired direction, the solution was drained off, and then the substrate was then exposed to the air containing moisture (FIG. 27). In the series of steps, a dehydrochlorination reaction was caused between SiCl groups of the above-mentioned chlorosilane-based surfactant and hydroxyl groups on the surface of the substrate, thereby generating the bonds represented by the following formulae (105) and (106). Furthermore, a reaction with moisture in the air was followed, thereby generating the bonds represented by formulae (107) and (108). Moreover, the carbon chains of the molecule adsorbed at this time were oriented at a certain degree in the direction in which the solution was drained off.

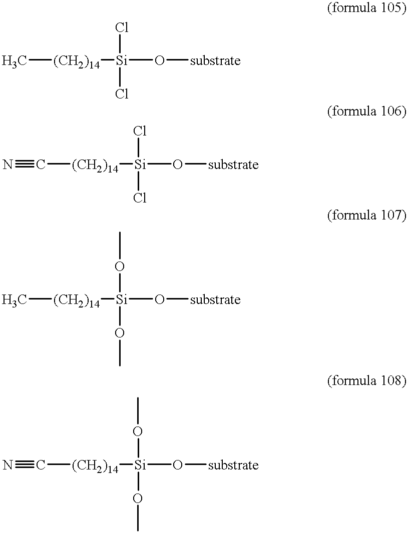

Next, the rubbing was performed by the use of a rubbing apparatus equipped with rayon cloth at a pushing depth of 0.3 mm, at 5 m/minute, and at 45° with respect to the lifting direction.

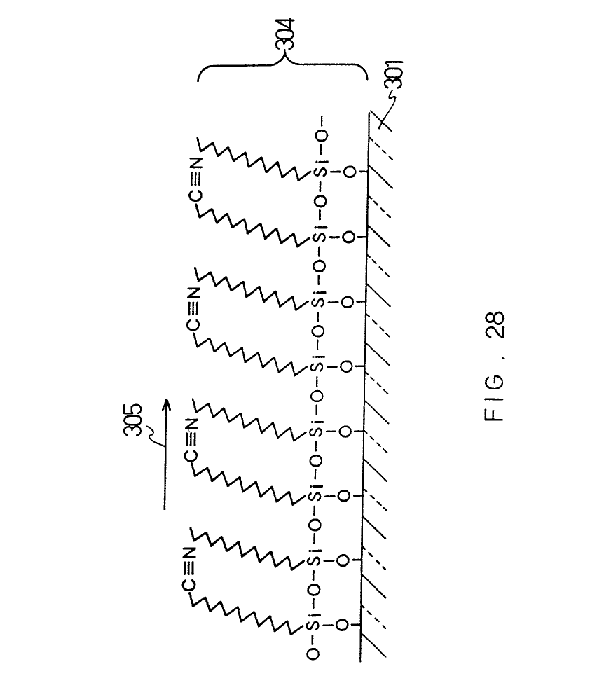

By performing the above-mentioned treatment, the chemisorption monomolecular film 304 formed by the reaction of the above-mentioned chlorosilane-based surfactants was formed along the rubbing direction 305 in the portion of the surface of the substrate comprising hydroxyl groups to the thickness of about 1.3 nm in a state of being chemically bonded through the covalent bonds of siloxane (FIG. 28). Moreover, the critical surface energy of the chemisorption film at this time was about 25 mN/m.

Furthermore, two substrates in this state were used and set so that the chemisorption films were facing each other. Thus, a liquid crystal cell of a 20-micron gap was assembled so that an anti-parallel orientation was obtained, and then nematic liquid crystal (ZLI4792 manufactured by Merck & Co., Inc.) was injected. When the orientation state was observed, the injected liquid crystal molecules were aligned substantially along the rubbing direction 305, namely, along the chemically adsorbed molecules at a pre-tilt angle of about 6° with respect to the substrate (FIG. 28).

At this time, when the composition ratio of CH₃(CH₂)₁₄SiCl₃ and NC(CH₂)₁₄SiCl₃ was changed in the range from 1:0 to 0:1 (preferably, in the range from 10:1 to 1:50), the critical surface energy was changed from 17 mN/m to 26 mN/m, and each of the pre-tilt angles was able to be controlled arbitrarily in the range from 86° to 33°. Furthermore, when a surfactant containing fluorine, for example CF₃(CF₂)₅(CH₂)₂SiCl₃, was added as a chemisorption compound, the critical surface energy was able to be reduced to 15 mN/m. In this case, the pre-tilt angle of liquid crystal was approximately 90°. However, when voltage was applied so as to drive, a highly uniform alignment change was observed.

As mentioned above, in this example, the silane-based surfactants providing different critical surface energy for the obtained film, and the same carbon chain length that was same as that of —(CH₂)₁₄— were used. However, when the surfactants having different carbon chain length (e.g., —(CH₂)ₙ—; n is an integer of 1 to 30) were mixed and used, if the critical surface energy was the same, the alignment direction was able to be controlled in the rubbing direction. The pre-tilt angle was able to be controlled by the critical surface energy.

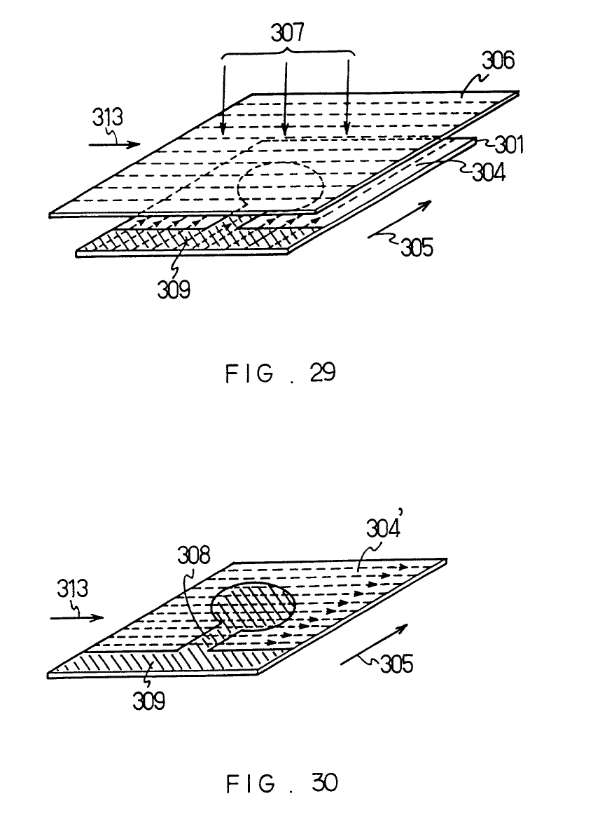

Furthermore, two substrates in this state were used, and a polarizing plate (HNP′B) 306 (manufactured by POLAROID) was disposed on the substrate so that the polarizing direction 313 was substantially orthogonal to a rubbing direction 305. Then, light 7 of 365 nm (i rays) (at 3.6 mW/cm² after passing through the polarizing plate) was radiated by using a 500 W extra-high pressure mercury lamp at 900 mJ (FIG. 29).

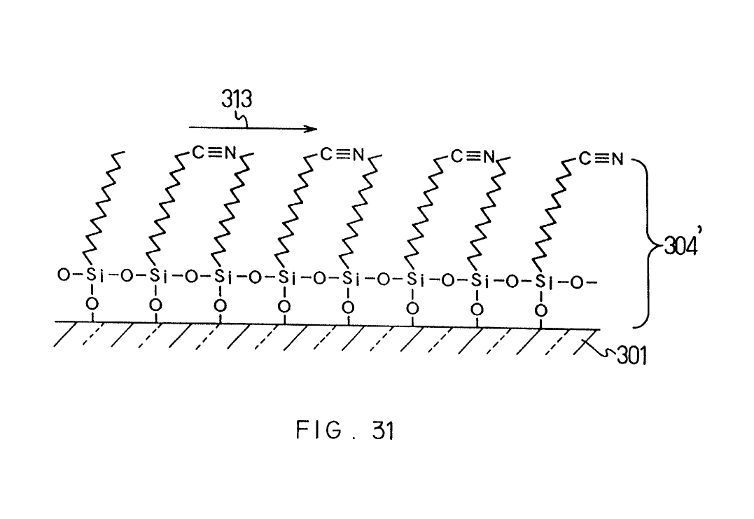

Thereafter, when the alignment direction of linear carbon chain in the above-mentioned chemisorption monomolecular film 304′ was observed, the critical surface energy and tilt angle were not changed, however, the alignment direction 308 was changed in the direction approximately parallel to the polarizing direction 313. In addition, the non-uniformity of the orientation was alleviated compared with that at the time of preliminary alignment (FIGS. 30 and 31). In the figures, numeral 309 denotes transparent electrodes.

Moreover, after rubbing was performed on the entire surface of the film beforehand, a patterned mask was disposed on the polarizing plate and irradiated with ultraviolet rays of wavelength of 365 nm at the energy of 800 to 1200 mJ. Consequently, the alignment direction was changed only in the irradiated portion. On the other hand, a plurality of portions in which the alignment direction was changed in pattern in the same plane of alignment film, namely, the portions in which liquid crystal was oriented along each of the rubbing direction 305 and the polarizing direction 313, was able to be provided. Furthermore, a plurality of monomolecular liquid crystal alignment films having a different alignment direction was able to easily be formed in pattern by repeating the steps in which a desired mask was disposed on the polarizing plate and then exposed to light under the same direction. In other words, a liquid crystal display film in which one pixel was multi-domain oriented was able to be provided.

Moreover, in this example, as light for exposure, light of 365 nm, that is, i rays from an extra-high pressure mercury lamp was used. However, light of 436 nm, 405 nm or 254 nm or light of 248 nm obtainable from a KrF excimer laser was able to be used in accordance with the degree of absorption of light by a film material. In particular, light of 248 nm or 254 nm exhibited high alignment efficiency because it was absorbed by most of the materials readily.

### EXAMPLE 18

In Example 17, before the step of chemisorption of the surfactant molecules comprising carbon chains or siloxane bond chains, an adsorption solution was prepared by dissolving a compound containing a plurality of chlorosilyl groups, and the substrate was immersed in the adsorption solution in a dry atmosphere. Then, a dehydrochlorination reaction was caused between hydroxyl groups contained on the surface of the substrate and the chlorosilyl groups of the compound containing a plurality of chlorosilyl groups. Thereafter, when a reaction with water followed, the remaining chlorosilyl groups were changed into hydroxyl groups, so that a chemisorption film comprising SiOH bonds, namely, a chemisorption film comprising a large number of hydroxyl groups, was formed on its surface.

For example, SiCl₄ was used as the silyl compound containing a plurality of chloro groups, and dissolved in n-octane so as to prepare an adsorption solution. Then, the substrate was immersed in the adsorption solution in a dry atmosphere. Since —OH groups were present on the surface, a dehydrochlorination reaction was caused at the interface so as to form the following formula (109) and/or formula (110). Thus, chlorosilane molecules 311 were fixed to the surface of the substrate via —SiO— bonds.

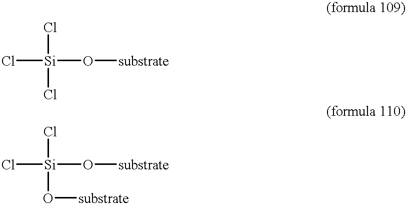

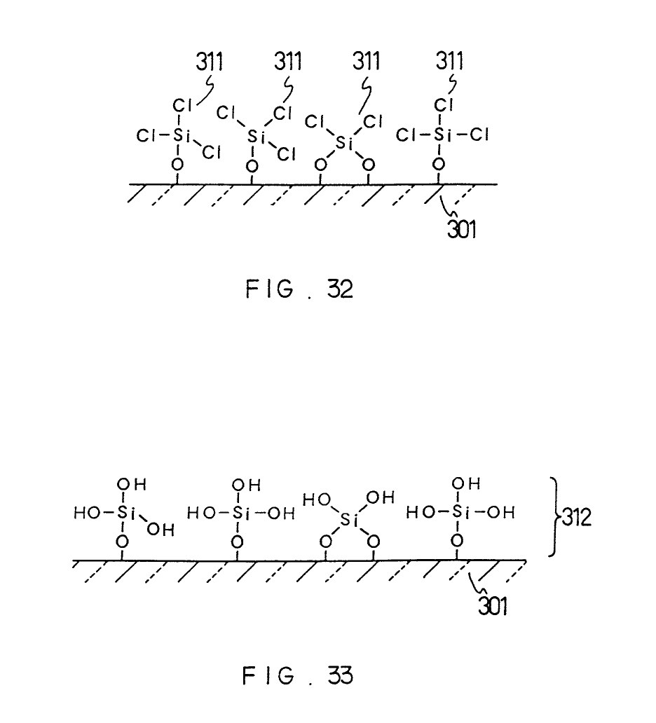

Thereafter, when the substrate was washed with a nonaqueous solvent such as chloroform, extra SiCl₄ molecules that had not reacted with the substrate were removed (FIG. 32). Furthermore, the substrate was taken out in the air so as to react with water. Then, a siloxane monomolecular adsorption film 312 containing a large number of SiOH bonds represented by the following formula (111) and/or formula (112) was obtained on the surface (FIG. 33).

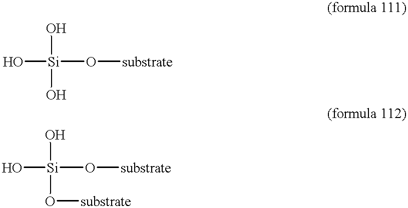

Moreover, at this time, when the process of washing with a nonaqueous solvent such as chloroform was omitted, a polysiloxane chemisorption provided with a large number of SiOH bonds in its surface was formed.

Since the obtained siloxane monomolecular film 312 was completely bonded to the substrate via chemical bonds of —SiO—, it was not peeled off. Furthermore, the obtained monomolecular film had a large number of SiOH bonds on its surface. In particular, the —OH groups were generated in a number about twice or three times the original number. The treated portion in this state was highly hydrophilic. Then, in this state, when the chemisorption step was performed by using the same surfactant as in Example 17, the monomolecular chemisorption film, the same as that in FIG. 28, comprising carbon chains obtained as a result of the reaction of the surfactant was formed in a thickness of about 1.5 nm by being chemically bonded through covalent bonds of siloxane via the siloxane monomolecular film 312. At this time, since the adsorption sites (OH groups in this case) on the surface of the substrate before adsorption were about twice or three times as many as that in Example 17, the density of the adsorbed molecules was made higher than that of Example 17. The treated portion became lipophilic.

Next, two substrates in this state were used and set so that the polarizing direction was substantially orthogonal to a lifting direction. Thereafter, when the alignment direction of linear carbon chain in the above-mentioned chemisorption monomolecular film was observed, the tilt angle was 86°, namely, somewhat increased as compared to that of Example 17. However, the alignment direction was changed approximately parallel to the rubbing direction. In addition, non-uniformity of the orientation was alleviated. Moreover, the critical surface energy at this time was 28 mN/m.

Two substrates in this state were used and set so that the chemisorption films were facing each other. Thus, a liquid crystal cell of a 20 micron gap was assembled so that an anti-parallel orientation was obtained, and then nematic liquid crystal (ZLI4792 manufactured by Merck & Co., Inc.) was injected. When the orientation state was observed, it was confirmed that the injected liquid crystal molecules were aligned along the chemically adsorbed molecules at a pre-tilt angle of about 46° with respect to the substrate.

### EXAMPLE 19

In the case where ClSi(CH₃)₂OSi(CH₃)₂OSi(CH₃)₂OSi(CH₃)₂Cl and CH₃(CH₂)₁₄SiCl₃ were mixed in the range from 1:0 to 0:1 and used as the chemisorption materials in place of CH₃(CH₂)₁₄SiCl₃ and NC(CH₃)₂(CH₂)₁₄SiCl₃ in Example 17, the critical surface energy was able to be controlled in the range from 35 mN/m to 21 mN/m in accordance with the mixing ratio. Furthermore, when a cell was assembled and the same liquid crystal was injected, the pre-tilt angle was able to be controlled in the range from 5° to 89°.

Moreover, when ClSi(CH3)₂OSi(CH₃)₂OSi(CH₃)₂OSi(CH₃)₂Cl comprising a linear siloxane bond chain was mixed with CH₃(CH₂)I₄SiCl₃ comprising a linear hydrocarbon chain at a desired ratio so as to form a film, a monomolecular chemisorption film comprising the molecules represented by the following formulae (113) and (114) in accordance with the mixing ratio, was obtained.

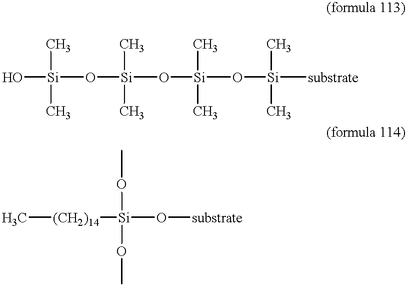

### EXAMPLE 20

In place of CH₃(CH₂)₁₄SiCl₃ and NC(CH₃)₂(CH₂)₁₄SiCl₃ in Example 17, HOOC(CH₂)₁₆Si(OCH₃)₃ and Br(CH₂)₈Si(OCH₃)₃ were mixed in the range from 1:0 to 0:1 and used as the chemisorption material, and reflux was performed at 100° C. for two hours at the time of chemisorption. In this case, the critical surface energy was controlled in the range from 56 mN/m to 31 mN/m in accordance with the mixing ratio. Furthermore, when a cell was assembled and then the same liquid crystal was able to be injected, the pre-tilt angle was controlled in the range from 0° to 27°.

### EXAMPLE 21

In place of CH₃(CH₂)₁₄SiCl₃ and NC(CH₃)₂(CH2)₁₄SiCl₃ in Example 17, CH₃CH₂C*HCH₃CH₂OCO(CH₂)1,SiCl₃ (wherein C* is an asymmetric carbon) and CH₃SiCl₃ were mixed in the range from 1:0 to 1:20 and used as the chemisorption substance so as to produce the same alignment film. In this case, the critical surface energy was able to be controlled in the range from 36 mN/m to 41 mN/m in accordance with the mixing ratio. Furthermore, when a cell was assembled and the same liquid crystal was injected, the alignment direction of liquid crystal was controlled in the rubbing direction and the pre-tilt angle was able to be controlled in the range from 3° to 0.1°.

### EXAMPLE 22

Next, a liquid crystal display device was actually produced by using the above-described liquid crystal alignment film.

First, as shown in FIG. 34, a chemisorption solution prepared by the same procedures as in Example 5 was applied onto a first substrate 323 and a second substrate 326 so as to form a monomolecular chemisorption film having a critical surface energy of 36 mN/m. The first substrate 323 includes first electrode group 321 arranged in a matrix array and transistor group 322 for driving the electrodes. The second substrate 326 includes a color filter group 324 and second electrodes 325 that are arranged so that they are facing the first electrode group.

Thereafter, the rubbing was performed in the same condition as Example 17, in the direction parallel to the electrode pattern. As a result, the same as Example 21, a liquid crystal alignment film 327 in which linear hydrocarbon group were realigned along the pattern of the electrode and critical surface energy was 37 mN/m was able to be produced. Next, the first substrate 323 and the second substrate 226 were positioned so that they were facing each other, and fixed with a spacer 328 and an adhesives 329 with about a 5 micron gap. Then, the TN liquid crystal 330 was injected into the first and second substrates, and the polarizing plates 331 and 332 were combined. Thus, a display device was completed. At this time, the pre-tilt angle of the injected liquid crystal was 3 Such a device was able to display images in the direction shown by arrow A by being entirely irradiated with backlight 333 and by driving each transistor with video signals.

### EXAMPLE 23

After the step of rubbing in Example 22, the same as in Example 17, when the process of disposing a patterned mask for dividing each pixel into four sections in a checkerboard pattern on the polarizing plate for exposure was carried out once, four sections having different alignment directions in a pattern were able to be obtained in one pixel. Thus, when the substrate provided with this alignment film was used, the angle of visibility the liquid crystal display apparatus was able to be significantly improved.

Industrial Applicability

As explained above, according to the liquid crystal alignment film of the present invention, the film in which uniformity of the liquid crystal alignment is well maintained even over a large area panel or surface step portions and a peeling resistance effect is high can be provided. Since the liquid crystal display apparatus of the present invention comprises such a liquid crystal alignment film as an element, the uniformity of the alignment film is not deteriorated even in a large area panel or step portions on the surface of the substrate, and the alignment property of liquid crystal can be well maintained.

Furthermore, the method for producing a liquid crystal alignment film of the present invention can provide an efficient and rational production of liquid crystal alignment film in which uniformity is well maintained in a large area panel or step portions on the surface of the substrate. With this method, increased area of a panel or step portions on the surface of the substrate basically do not affect the uniformity of the alignment property. Thus, if the area of the panel is increased, the efficiency of productivity basically is not lowered.

Furthermore, the translucent substrate for exposure of the present invention can provide a simple and efficient production method of the present invention. The method for producing a translucent substrate for exposure of the present invention can provide extremely simple production of the translucent substrate for exposure.

Furthermore, the present invention efficiently and rationally can provide an alignment film for liquid crystal display apparatus having a high reliability in which the alignment direction of liquid crystal is controlled by the rubbing direction, and the pre-tilt angle of liquid crystal is controlled by the surface energy of the monomolecular film. Furthermore, at the time of production of the liquid crystal alignment film, by performing the step of exposure with a patterned mask disposed on the polarizing plate, a plurality of portions in which only the alignment directions in pattern are different in the same plane of alignment film can be provided. A liquid crystal display apparatus having a multi-domain, which was difficult to be obtained only by the conventional rubbing treatment in which the orientation of each pixel is divided into pluralities can be produced efficiently and rationally.

Furthermore, with the use of such a liquid crystal alignment film, compared with the conventional case where the alignment film was produced by rubbing resins, the SiO₂ protective film formed in or on an electrode was hard. Therefore, the defect incidence is reduced and the alignment film having the desired tilt angle can be obtained, so that a liquid crystal display apparatus having a remarkably high yield, a low cost and high reliability and excellent display imaging can be provided.

Moreover, the alignment film formed by being adsorbed can combine with a liquid crystal having a certain surface energy, for example, a nematic liquid crystal or ferroelectric liquid crystal. Consequently, a liquid crystal alignment film in which the alignment direction and tilt angle can be controlled and further an alignment regulation force is great can be produced efficiently and rationally.

Furthermore, according to the present invention, a method for producing a liquid crystal alignment film employs the step of contacting the surface of the substrate with chemisorption solution prepared by using a silane-based surfactant molecule containing at least a functional group for controlling the surface energy of the film at the terminal or partially so as to cause a chemical reaction between the surfactant molecules and hydrophilic groups contained on the surface thereby fixing the surfactant molecule to the surface of the substrate at one end and the step of rubbing. Therefore, the present invention can provide a novel alignment film which is thin and excellent in uniformity as compared with the conventional alignment film and in which the alignment direction of the injected liquid crystal can be controlled in the rubbing direction and the pre-tilt angle is controlled by the surface energy of the monomolecular film.

Furthermore, by carrying out the steps of disposing a patterned mask on the polarizing plate, a plurality of sections each having a different alignment direction in pattern can be formed in the alignment film in the same plane. Thus, the multi-domain type liquid crystal display apparatus in which the alignment of each pixel is divided into pluralities, which was difficult to be formed by the conventional rubbing method, can be produced efficiently and rationally.

Furthermore, such an alignment film is firmly bonded to the surface of the substrate via a covalent bond. Thus, a liquid crystal display apparatus having a remarkably high reliability can be provided.

Moreover, since the alignment film formed by being adsorbed can incorporate a liquid crystal having a certain surface energy, for example, a nematic liquid crystal or ferroelectric liquid crystal, a liquid crystal alignment film in which the alignment direction and tilt angle can be controlled and alignment regulation force is great can be produced efficiently and rationally.

1. A liquid crystal alignment film, which is a film comprising a group of molecules chemically adsorbed to a surface of a substrate at one end, said group of molecules comprising molecules having a linear carbon chain, wherein at least a part of said linear carbon chains are selectively polymerized with each other.

2. The liquid crystal alignment film according to claim 1, wherein the linear carbon chain is polymerized, thereby controlling the tilt of said linear carbon chain with respect to the substrate at a constant angle.

3. The liquid crystal alignment film according to claim 2, wherein the group of molecules includes molecules shorter than the molecules having a linear carbon chain; the tilt of said linear carbon chain with respect to the substrate being controlled at a constant angle by the presence of said shorter molecules; at least a part of said linear carbon chains being selectively polymerized with each other, thereby increasing or decreasing the tilt of said linear carbon chain with respect to the substrate from said angle; and by increasing or decreasing the tilt, a region in which the linear carbon chains are polymerized forms a convex portion or a concave portion.

4. The liquid crystal alignment film according to claim 2, wherein the region in which the linear carbon chains are polymerized forms a plurality of lines, which are substantially parallel to each other, on the surface of the substrate via a region in which the linear carbon chains are not polymerized.

5. The liquid crystal alignment film according to claim 1, wherein the molecules having a linear carbon chain are fixed to the surface of the substrate at one end via siloxane bonds.

6. The liquid crystal alignment film according to claim 1, wherein the molecules constituting said group of molecules are bonded to each other via siloxane bonds.

7. A method for producing a liquid crystal alignment film, comprising steps of contacting a surface of a substrate with a chemisorption solution so as to cause a chemical reaction between surfactant molecules having linear carbon chains contained in the chemisorption solution and hydrophilic groups contained on the surface, thereby fixing said molecules to said surface at one end; and providing at least a part of the linear carbon chains with an alignment property with respect to the substrate by selectively exposing a film comprising the group of molecules including said molecules to light.

8. The method for producing a liquid crystal alignment film according to claim 7, wherein the step of providing at least a part of the linear carbon chains with the alignment property with respect to the substrate is a step of controlling the tilt of said linear carbon chains with respect to the substrate to a constant angle by polymerizing said linear carbon chains.

9. The method for producing a liquid crystal alignment film according to claim 8, wherein along with the surfactant molecules having linear carbon chains, molecules having shorter molecular length than the surfactant molecules are fixed at one end to the surface of the substrate, thereby controlling the tilt of said linear carbon chain with respect to the substrate to a constant angle; at least a part of said linear carbon chains are selectively polymerized with each other, thereby increasing and decreasing the tilt of said linear carbon chain with respect to the substrate from said angle; and by increasing or decreasing the tilt, a region in which the linear carbon chains are polymerized forms a convex portion or a concave portion.

10. The method for producing a liquid crystal alignment film according to claim 7, which further comprises a step of washing the surface of the substrate with an organic solvent after the step of fixing the surfactant molecules having linear carbon chains to said surface at one end and before the step of exposing the film comprising a group of molecules including said molecules to light.

11. The method for producing a liquid crystal alignment film according to claim 10, wherein the organic solvent is drained off the surface of the substrate in a predetermined direction during the step of washing the surface of the substrate with organic solvent, thereby aligning the linear carbon chains in the predetermined direction.

12. The method for producing a liquid crystal alignment film according to claim 11, wherein the organic solvent is drained off the surface of the substrate in the predetermined direction, thereby controlling the tilt of said linear carbon chains with respect to the substrate at a constant angle; at least a part of said linear carbon chains are selectively polymerized with each other, thereby increasing or decreasing the tilt of said linear carbon chains with respect to the substrate from said angle; and by increasing or decreasing the tilt, a region in which the linear carbon chains are polymerized forms a convex portion or a concave portion.

13. The method for producing a liquid crystal alignment film according to claim 10, wherein a nonaqueous organic solvent containing at least one selected from the group consisting of an alkyl group, a carbon fluoride group, a carbon chloride group and a siloxane group is used as the organic solvent.

14. The method for producing a liquid crystal alignment film according to claim 8, wherein exposure is performed via a translucent substrate provided with a plurality of convexities and concavities extending in approximately the same direction, so that the region in which the linear carbon chains are polymerized forms a plurality of lines, which are substantially parallel to each other, on the surface of the substrate via a region in which the linear carbon chains are not polymerized.

15. The method for producing a liquid crystal alignment film according to claim 14, wherein the exposure is performed via a translucent substrate having a width and depth of a concave portion of the convexities and concavities on the surface in the range from 0.01 to 0.5 μm.

16. The method for producing a liquid crystal alignment film according to claim 14, wherein light reaching the film through a translucent substrate is diffracted by the convexities and concavities of said translucent substrate.

17. The method for producing a liquid crystal alignment film according to any one of claims 7 to 16, wherein the surfactant molecules having linear carbon chains comprise a silicone-containing group selected from the group consisting of a chlorosilyl group, an alkoxysilyl group and an isocyanate silyl group at the terminal.

18. The method for producing a liquid crystal alignment film according to claim 8, wherein the surfactant molecules having linear carbon chains comprise a photopolymerization functional group in the linear carbon chain.

19. The method for producing a liquid crystal alignment film according to claim 18, wherein the photopolymerization functional group is a diacetylene group.

20. A method for producing a liquid crystal alignment film comprising the steps of
contacting a surface of a substrate with a chemisorption solution so as to cause a chemical reaction between surfactant molecules having linear carbon chains contained in said chemisorption solution and hydrophilic groups contained on said surface of the substrate, thereby fixing said molecules to said surface at one end;
washing and drying said surface by draining off the organic solvent contacted with said surface in the predetermined direction; and
exposing a film comprising a group of molecules comprising said molecules to light via a translucent substrate, wherein said translucent substrate is provided with a plurality of convexities and concavities extending in approximately the same direction and is positioned so that the direction in which said convexities and concavities extend is not orthogonal to the direction in which the solvent is drained off.

21. A liquid crystal display apparatus comprising two substrates and liquid crystal, said two substrates being positioned with a predetermined space and being provided with a liquid crystal alignment film on at least one of surfaces facing each other, and said liquid crystal that is interposed between said two substrates in which alignment is regulated by said liquid crystal alignment film, wherein said liquid crystal alignment film is a film comprising a group of molecules chemically adsorbed to the surface of the substrate at one end, said group of molecules comprises molecules having linear carbon chains, wherein at least a part of said linear carbon chains are selectively polymerized with each other.

22. The liquid crystal display apparatus according to claim 21, which comprises a liquid crystal alignment film wherein the linear carbon chains are polymerized, thereby controlling the tilt of said linear carbon chain with respect to the substrate at a constant angle.

23. The liquid crystal display apparatus according to claim 21, wherein at least one thin film member selected from the group consisting of an electrode, a color filter and a thin film transistor is formed on a part of the surface of the substrate to form step portions on said surface, and the region including said portions has a liquid crystal alignment film.

24. The liquid crystal display apparatus according to claim 21, wherein the liquid crystal alignment film includes a plurality of regions having different alignment directions.

25. A method for producing a liquid crystal alignment film comprising a step of forming a plurality of convexities and concavities extending in approximately the same direction on a film formed on a surface of a substrate by a step including exposure.

26. The method for producing a liquid crystal alignment film according to claim 25, wherein the width of the concave portion of the convexities and concavities is in the range from 0.01 to 0.5 μm.

27. The method for producing a liquid crystal alignment film according to claim 25, wherein the film is a chemisorption polymer film.

28. The method for producing a liquid crystal alignment film according to claim 27, wherein the chemisorption polymer film is bonded to the surface of the substrate via siloxane bonds.

29. A method for producing a liquid crystal alignment film comprising the steps of
forming a film comprising a photosensitive polymer on a surface of a substrate;
exposing said film to light so that an exposed portion forms lines, which are approximately parallel with each other, via an unexposed portion; and
forming a plurality of convexities and concavities extending in approximately the same direction by removing a part of said film by the use of the difference in the molecular structure of the molecules constituting said film generated by exposure.

30. The method for producing a liquid crystal alignment film according to claim 29, wherein the difference in the molecular structure of the molecule constituting the film generated by exposure is a difference in the polymerization degree of the molecules constituting said film.

31. The method for producing a liquid crystal alignment film according to claim 29, wherein the exposure is performed via a translucent substrate provided with a plurality of convexities and concavities extending in approximately the same direction on its surface.

32. The method for producing a liquid crystal alignment film according to claim 31, wherein the film is exposed to light so that an exposed portion forms lines extending in approximately the same direction as the direction in which the convexities and concavities on the surface of said translucent substrate extend.

33. The method for producing a liquid crystal alignment film according to claim 31, wherein patterns of convexities and concavities on the surface of the translucent substrate are transferred as patterns of exposed portion and unexposed portion.

34. The method for producing a liquid crystal alignment film according to claim 31, wherein the width and the depth of the concave portion of the convexities and concavities are in the range from 0.01 to 0.5 μm.

35. The method for producing a liquid crystal alignment film according to claim 29, wherein the film comprising the photosensitive polymer is formed by contacting a solution containing the photosensitive surfactant molecules with the surface of the substrate so that said surfactant molecules are chemically adsorbed to the substrate.

36. The method for producing a liquid crystal alignment film according to claim 35, wherein the surfactant molecules having linear carbon chains comprise a silicone-containing group selected from the group consisting of a chlorosilyl group, an alkoxysilyl group and an isocyanate silyl group at the terminal.

37. A translucent substrate for exposing a liquid crystal alignment film to light, which comprises a plurality of convexities and concavities extending in approximately the same direction on its surface.

38. The translucent substrate for exposing a liquid crystal alignment film to light according to claim 37, wherein the width and depth of the convexities and concavities on the surface are in the range from 0.01 to 0.5 μm.

39. A method for producing a translucent substrate for exposing a liquid crystal alignment film to light, which comprises a plurality of convexities and concavities extending in approximately the same direction on its surface, said method comprising the steps of washing a transparent substrate; and rubbing a surface of said transparent substrate with a material having a higher hardness than said transparent substrate in approximately the same direction.

40. The method for producing a translucent substrate for exposing a liquid crystal alignment film to light according to claim 39, wherein the transparent substrate is a polycarbonate resin or an acrylic resin.

41. A method for producing a translucent substrate for exposing a liquid crystal alignment film to light, which comprises a plurality of convexities and concavities extending in approximately the same direction on its surface, comprising the steps of
washing a transparent substrate;
applying a photosensitive resist to a surface of said transparent substrate;
exposing said photosensitive resist to light so that exposed portions form a plurality of lines, which are approximately parallel, via an unexposed portion; and
developing said photosensitive resist.

42. The method for producing a translucent substrate for exposing a liquid crystal alignment film to light according to claim 41, wherein the photosensitive resist is exposed to light by using at least one selected from the group consisting of ultraviolet rays, far ultraviolet rays and electron beam.

43. The method for producing a translucent substrate for exposing the liquid crystal alignment film to light according to claim 41, further comprising, after the step of developing the photosensitive resist, an etching the surface by at least one method selected from the group consisting of chemical etching, plasma etching and sputter etching.

44. A liquid crystal display apparatus comprising two substrates and liquid crystal, said two substrates being positioned with a predetermined space and being provided with a liquid crystal alignment film on at least one of surfaces facing each other, and said liquid crystal that is interposed between said two substrates having an alignment that is regulated by said liquid crystal alignment film, wherein said liquid crystal alignment film has a plurality of concavities and convexities extending in approximately the same direction formed on the surface contacting with liquid crystal by a step including exposure.

45. The liquid crystal display apparatus according to claim 44, wherein at least one thin film member selected from the group consisting of an electrode, a color filter and a thin film transistor is formed on a part of the surface of the substrate to form step portions on said surface, and the region including said step portions has a liquid crystal alignment film.

46. The liquid crystal display apparatus according to claim 44, wherein the liquid crystal alignment film includes a plurality of regions having different alignment directions.

47. A liquid crystal alignment film, which is a monomolecular film formed on a surface of a substrate which is provided with electrodes beforehand and on which a rubbing treatment is performed directly or after forming an arbitrary thin film.

48. The liquid crystal alignment film according to claim 47, wherein the molecules constituting the monomolecular film comprise carbon chains or siloxane bond chains, and a part of or the terminal of the carbon chain or the siloxane bond chain contains at least one functional group for controlling a surface energy of the film.

49. The liquid crystal alignment film according to claim 47, wherein a plurality of types of silane-based surfactants each having a different critical surface energy are mixed and used as the molecules constituting the film, and the fixed film is controlled so as to have a desired critical surface energy.

50. The liquid crystal alignment film according to claim 47, wherein the functional group for controlling the surface energy is at least one organic group selected from the group consisting of a carbon trifluoride group (—CF₃), a methyl group (—CH₃), a vinyl group (—CH═CH₂), an allyl group (—CH═CH—), an acetylene group (carbon-carbon triple bonds), a phenyl group (—C₆H₅), a phenylene group (—C₆H₄—), a halogen atom, an alkoxy group (—OR; R represents an alkyl group), a cyano group (—CN), an amino group (—NH₂), a hydroxyl group (—OH), a carbonyl group (═CO), a carboxy group (—COO—) and a carboxyl group (—COOH).

51. The liquid crystal alignment film according to claim 47, wherein the molecules constituting the film contain Si at the terminals.

52. A method for producing a monomolecular liquid crystal alignment film, comprising steps of performing a rubbing treatment on a surface of a substrate provided with electrodes beforehand in an arbitrary direction directly or after forming an arbitrary protective film; and contacting the surface of the substrate with a chemisorption solution prepared by using a silane-based surfactant comprising carbon chains or siloxane bond chains, wherein a part of or the terminal of the carbon chain or the siloxane bond chain contains at least one functional group for controlling a surface energy of the film so as to cause a chemical reaction between the surfactant molecules in said chemisorption solution and the surface of the substrate, thereby fixing and bonding said surfactant molecules to the surface of the substrate at one end.

53. The method for producing a monomolecular liquid crystal alignment film according to claim 52, wherein a silane-based surfactant containing linear carbon chains or siloxane bond chains and chlorosilyl groups or alkoxysilyl groups or isocyanate silyl groups is used as the surfactant.

54. The method for producing a monomolecular liquid crystal alignment film according to claim 52, wherein a plurality of types of silicon-based surfactants having different critical surface energies are mixed and used as the surfactant.

55. The method for producing a monomolecular liquid crystal alignment film according to claim 52, wherein the terminal of or a part of the carbon chain or the siloxane bond chain comprises at least one organic group selected from the group consisting of a carbon trifluoride group (—CF,), a methyl group (—CH₃), a vinyl group (—CH═CH₂), an allyl group (—CH═CH—), an acetylene group (carbon-carbon triple bonds), a phenyl group (—C₆H₅), a phenylene group (—C₆H₄—), a halogen atom, an alkoxy group (—OR; R represents an alkyl group), a cyano group (—CN), an amino group (—NH₂), a hydroxyl group (—OH), a carbonyl group (═CO), an carboxy group (—COO—) and a carboxyl group (—COOH).

56. The method for producing a monomolecular liquid crystal alignment film according to claim 52, which further comprises, after the step of bonding and fixing the surfactant molecules to the surface of the substrate at one end, the steps of washing the substrate with an organic solvent and tilting the substrate in a desired direction so as to drain off the solvent, thereby aligning said fixed molecules in the direction in which the solvent was drained off.

57. The method for producing a monomolecular liquid crystal alignment film according to claim 56 further comprising, after the step of aligning the molecules, a step of exposure through a polarizing film so as to realign said aligned molecules in a desired direction.

58. The method for producing a monomolecular liquid crystal alignment film according to claim 56, wherein a silane-based surfactant containing linear carbon chains or siloxane bond chains and chlorosilyl groups or isocyanate silyl groups is used as the surfactant, and a nonaqueous organic solvent containing no water is used as the washing organic solvent.

59. The method for producing a monomolecular liquid crystal alignment film according to claim 58, wherein a solvent containing an alkyl group, a carbon fluoride group or a carbon chloride group or a siloxane group is used as the nonaqueous organic solvent.

60. The method for producing a monomolecular liquid crystal alignment film according to claim 52, further comprising, after the step of rubbing and before the step of fixing the surfactant molecules at one end, a step of forming a film containing a large number of SiO groups to form a monomolecular film via said film.

61. A liquid crystal display apparatus, wherein a film is formed as an alignment film for liquid crystal on a surface provided with electrodes of at least one of two substrates which are provided with facing electrodes and on which a rubbing is performed directly or after forming an arbitrary thin film, directly or indirectly via another film, said film being constituted by molecules containing carbon chains or siloxane bond chains, the terminal of or a part of the carbon chain or the siloxane bond chain containing at least one functional group for controlling a surface energy of the film; and liquid crystal is interposed between said two facing electrodes via said alignment film.

62. The liquid crystal display apparatus according to claim 61, wherein said film is formed as an alignment film on each of the surfaces of the two substrates which is provided with the facing electrodes and on which a rubbing is performed.

63. The liquid crystal display apparatus according to claim 61, wherein the film on the surface of the substrate comprises a plurality of patterned sections, each having a different alignment direction.

64. The liquid crystal display apparatus according to claim 60, wherein the facing electrodes are formed on one surface of the substrate.

65. A method for producing a liquid crystal display apparatus comprising steps of performing a rubbing treatment on the surface of a first substrate including a first electrode group arranged in a matrix array beforehand directly or after forming an arbitrary thin film; contacting the surface of the substrate with a chemisorption solution prepared by using a silane-based surfactant comprising carbon chains or siloxane bond chains, wherein a part of or the terminal of the carbon chain or the siloxane bond chain contains at least one functional group for controlling a surface energy of the film so as to cause a chemical reaction between the surfactant molecules in said chemisorption solution and the surface of the substrate, thereby fixing and bonding said surfactant molecules to the surface of the substrate at one end; tilting the substrate in a desired direction so as to drain off the solvent, thereby aligning said fixed molecules in the direction in which the solvent was drained off, attaching the first substrate including the first electrode group to a second substrate or a second substrate including second electrode or electrode group in a manner in which the faces provided with the electrodes are facing inward with a predetermined gap while adjusting the position; and injecting a predetermined liquid crystal between the first substrate and the second substrate.

66. The method for producing a liquid crystal display apparatus according to claim 65, further comprising a step of exposure to light polarized in a desired direction through a polarizing plate so as to align the orientations of said surfactant molecules in a specific direction at a desired tilt after the step of aligning the fixed molecules.

67. The method for producing a liquid crystal display apparatus according to claim 66, wherein in the step of exposure to light polarized in a desired direction through a polarizing plate so as to align the orientations of the bonded surfactant molecules in a specific direction at a desired tilt, the step of exposure with a patterned mask disposed on said polarizing plate is performed several times, thereby forming a plurality of patterned sections each having a different alignment direction on one face of the alignment film.

68. A liquid crystal alignment film, which is a monomolecular film formed on the surface of the substrate provided with predetermined electrodes, wherein rubbing is performed on the surface of the film.

69. The liquid crystal alignment film according to claim 68, wherein the molecules constituting the film have carbon chains or siloxane bond chains, and the terminal of or a part of the carbon chain or the siloxane bond chain contains at least a functional group for controlling the surface energy of the film.

70. The liquid crystal alignment film according to claim 68, wherein a plurality of types of silane-based surfactants each having a different critical surface energy are mixed and used as the molecules constituting the film, and the fixed film is controlled so as to have a desired critical surface energy.

71. The liquid crystal alignment film according to claim 69, wherein the functional group for controlling the surface energy is at least one organic group selected from the group consisting of a carbon trifluoride group (—CF₃), a methyl group (—CH₃), a vinyl group (—CH═CH₂), an allyl group (—CH═CH—), an acetylene group (carbon-carbon triple bonds), a phenyl group (—C₆H₅), a phenylene group (—C₆H₄—), a halogen atom, an alkoxy group (—OR; R represents an alkyl group), a cyano group (—CN), an amino group (—NH₂), a hydroxyl group (—OH), a carbonyl group (CO), a carboxy group (—COO—) and a carboxyl group (—COOH).

72. The liquid crystal alignment film according to claim 68, wherein the molecules constituting the film contain Si at the terminals.

73. A method for producing a monomolecular liquid crystal alignment film comprising the steps of contacting the surface of the substrate with a chemisorption solution prepared by using a silane-based surfactant comprising carbon chains or siloxane bond chains and at least a part of or the terminal of the carbon chain or the siloxane bond chain contains at least one functional group for controlling a surface energy of the film so as to cause a chemical reaction between the surfactant molecules in said chemisorption solution and the surface of the substrate, thereby fixing and bonding said surfactant molecules to the surface of the substrate at one end; and rubbing the surface.

74. The method for producing a monomolecular liquid crystal alignment film according to claim 73, wherein a silane-based surfactant containing linear carbon chains or siloxane bond chains, and, chlorosilyl groups or alkoxysilyl groups or isocyanate silyl groups is used as the surfactant.

75. The method for producing a monomolecular liquid crystal alignment film according to claim 73, wherein a plurality of types of silicon-based surfactants having different critical surface energies are mixed and used as the surfactant.

76. The method for producing a monomolecular liquid crystal alignment film according to claim 73, wherein a terminal of or a part of the carbon chain or the siloxane bond chain comprises at least one organic group selected from the group consisting of a carbon trifluoride group (—CF₃), a methyl group (—CH₃), a vinyl group (—CH═CH₂), an allyl group (—CH═CH—), an acetylene group (carbon-carbon triple bonds), a phenyl group (—C₆H₅), a phenylene group (—C₆H₄—), a halogen atom, an alkoxy group (—OR; R represents an alkyl group), a cyano group (—CN), an amino group (—NH₂), a hydroxyl group (—OH), a carbonyl group (═CO), an carboxy group (—COO—) and a carboxyl group (—COOH).

77. The method for producing a monomolecular liquid crystal alignment film according to claim 73, which further comprises steps of washing the surface of the substrate with an organic solvent after the step of bonding and fixing the surfactant molecules to the surface of the substrate at one end, tilting the substrate in a desired direction so as to drain off the solvent, thereby preliminarily aligning said fixed molecules in the direction in which the solvent was drained off, and then performing the rubbing.

78. The method for producing a monomolecular liquid crystal alignment film according to claim 73, wherein after the rubbing is performed on the monomolecular film so as to orientate said aligned molecules in the predetermined direction, a step of exposure with a patterned mask disposed on the polarizing plate is performed, thereby forming a plurality of patterned sections each having a different alignment direction on one face of the alignment film.

79. The method for producing a monomolecular liquid crystal alignment film according to any one of claims 73 to 78, wherein a silane-based surfactant containing linear carbon chains or siloxane bond chains and chlorosilyl groups or isocyanate silyl groups is used as the surfactant, and nonaqueous organic solvent containing no water is used as the washing organic solvent.

80. The method for producing a monomolecular liquid crystal alignment film according to claim 79, wherein a solvent containing an alkyl group, a carbon fluoride group or a carbon chloride group or a siloxane group is used as the nonaqueous organic solvent.

81. The method for producing a monomolecular liquid crystal alignment film according to claim 73, which further comprises steps of forming a film containing a large number of SiO groups before the step of fixing the surfactant molecules at one end, forming the monomolecular film via said film and then performing rubbing.

82. A liquid crystal display apparatus, wherein a monomolecular film is formed as an alignment film for liquid crystal directly or indirectly via other film on a surface provided with electrodes of at least one substrate of two substrates provided with facing electrodes, on which a rubbing treatment is performed, said film being constituted by molecules containing carbon chains or siloxane bond chains, the terminal of or a part of the carbon chain or the siloxane bond chain containing at least one functional group for controlling a surface energy of the film; and liquid crystal is interposed between said two facing electrodes via the alignment film.

83. The liquid crystal display apparatus according to claim 82, wherein said film is formed as an alignment film on each of two substrates providing with electrodes.

84. The liquid crystal display apparatus according to claim 82, wherein the film on the surface of the substrate comprises a plurality of patterned sections each having a different alignment direction.

85. The liquid crystal display apparatus according to claim 82, wherein the facing electrodes are formed on one surface of the substrate.

86. A method for producing a liquid crystal display apparatus, comprising steps of contacting, directly or after forming an arbitrary thin film, a surface of a first substrate including a first electrode group arranged in a matrix array beforehand with a chemisorption solution prepared by using a silane-based surfactant comprising carbon chains or siloxane bond chains, wherein a part of or the terminal of the carbon chain or the siloxane bond chain contains at least one functional group for controlling a surface energy of the film so as to cause a chemical reaction between the surfactant molecules in said chemisorption solution and the surface of the substrate, thereby fixing and bonding said surfactant molecules to the surface of the substrate at one end; washing the substrate with an organic solvent, followed by a step of bonding and fixing the surfactant molecules to the surface of the substrate at one end; tilting the substrate in a desired direction so as to drain off the solvent, thereby preliminarily aligning said fixed molecules in the direction in which the solvent was drained off; rubbing the surface; fixing and attaching the first substrate including the first electrode group to a second substrate or a second substrate including second electrode or electrode group in a manner in which the faces provided with the electrodes are facing inward with a predetermined gap while adjusting the position; and injecting a predetermined liquid crystal between the first substrate and the second substrate.

87. The method for producing a liquid crystal display apparatus according to claim 86, wherein after said bonded surfactant molecules are aligned in the predetermined direction by rubbing, a step of exposure with a patterned mask disposed on the polarizing plate is performed, thereby forming a plurality of patterned sections each having a different alignment direction on one face of the alignment film.
